(19) United States
(12) Patent Application Publication
(10) Pub. No.: US 2025/0217894 A1
(43) Pub. Date: Jul. 3, 2025

(54) INDIVIDUAL INSURANCE INVESTMENT PRODUCT WITH MACHINE LEARNING BASED MATCHING

(71) Applicant: James A. SEALE, Key Largo, FL (US)

(72) Inventor: James A. SEALE, Key Largo, FL (US)

(21) Appl. No.: 19/009,655

(22) Filed: Jan. 3, 2025

Related U.S. Application Data
(60) Provisional application No. 63/617,335, filed on Jan. 3, 2024.

(51) Int. Cl. G06Q 40/08

(52) U.S. Cl. CPC G06Q 40/08

(57) ABSTRACT

Techniques for individual insurance investment products are provided. Instead of an insured entity paying premiums to a third party insurer, over time, the insured entity may purchase an individual product. The insured entity may fully fund the product, at the time of purchase, and invest the product in any form of desired investment. The insured entity may then make a claim against the product, as necessary.

### CROSS-REFERENCE TO RELATED APPLICATIONS

This Application claims the benefit of and priority to U.S. Provisional Patent Application No. 63/617,335, filed on Jan. 3, 2024, the entire contents of which are incorporated herein by reference.

### INTRODUCTION

Traditional insurance products typically provide a form of protection against financial loss for the insured. The insurer gathers a broad pool of customers, each of whom pays a premium to purchase a policy and insure against financial outlay in particular circumstances. The insured is entitled to make a claim against the policy, in the particular defined circumstances, and receive payment in return. The insurer meanwhile can invest received premiums, and earn investment profits on the surplus between the received premiums and outlays to pay claims, commonly called float. While these traditional products have benefits in a variety of circumstances, they also have many disadvantages that could be avoided with one or more of the improved techniques described herein.

### DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts a computing environment for an individual insurance investment product, according to one embodiment.

FIG. 2 depicts a block diagram for a controller for an individual insurance investment product according to one embodiment.

FIG. 3 is a flowchart illustrating generating and fulfilling an individual insurance investment product, according to one embodiment.

FIG. 4 is a flowchart illustrating generating an individual insurance investment product, according to one embodiment.

FIG. 5 is a flowchart illustrating matching a user to a product type for an individual insurance investment product, according to one embodiment.

FIG. 6 is a flowchart illustrating training a product match ML model, according to one embodiment.

FIG. 7 is a flowchart illustrating inferring a product match using an ML model, according to one embodiment.

FIG. 8 is a flowchart illustrating matching a user to investment options, according to one embodiment.

FIG. 9 is a flowchart further illustrating training an investment match ML model, according to one embodiment.

FIG. 10 is a flowchart illustrating inferring an investment match using an ML model, according to one embodiment.

FIGS. 11A-B illustrate a user interface for an individual insurance investment product, according to one embodiment.

FIG. 12 is a flowchart illustrating generating an individual insurance investment product using a blockchain, according to one embodiment.

FIG. 13 is a flowchart illustrating fulfilling an individual insurance investment product, according to one embodiment.

FIG. 14 is a flowchart illustrating verifying an individual insurance investment product using a blockchain, according to one embodiment.

FIG. 15 is a flowchart illustrating generating and fulfilling a back-to-back insurance product, according to one embodiment.

FIG. 16 is a flowchart illustrating selecting an investment option for a back-to-back insurance product, according to one embodiment.

FIG. 17 is a flowchart illustrating variable policy limits for an insurance product, according to one embodiment.

FIG. 18 is a flowchart illustrating an insurance savings account, according to one embodiment.

FIG. 19 is a flowchart illustrating an insurance reserve account, according to one embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

As discussed above, in traditional insurance products the insurer earns investment profits on float (e.g., the difference between collected premiums and claims paid). While this is beneficial to the insurer, it is not ideal for the insured. It would be beneficial to an insured entity to earn those investment profits itself, instead of providing them to the insurer. In an embodiment, an insured entity can be any suitable entity (e.g., a person, a corporation, a partnership, a trust, or any other suitable entity). Further, traditional products create incentives for insurers to minimize payout by making claims administratively difficult and complex. And insurers are at risk of being unable to fund necessary claims, if a large number of claimants are harmed at the same time and make claims in a short period of time (e.g., due to a natural disaster or other large scale event).

In an embodiment, one or more of these disadvantages can be improved by using an individual insurance investment product, as described further below. Instead of an insured entity paying premiums to a third party insurer, over time, the insured entity could purchase an individual product. The insured entity could fully fund the product, at the time of purchase, and invest the product in any form of desired investment. The insured entity could then make a claim against the product, as necessary.

Meanwhile the investment profits gained by the product would inure to the benefit of the insured entity, instead of a third party insurer. The insured entity could maintain the product as long as desired, and make suitable claims against the product, and could then close the product and receive the remaining funds (e.g., including both remaining initial funds and investment profits, as with a traditional investment fund). This has numerous advantages, including potentially very large additional investment profits, easier and quicker payment of claims (e.g., because the product is funded with the insured's own money, there is no incentive to withhold payment of valid claims), and reduced risk that the funds will be unavailable when necessary (e.g., because the product is funded by the insured's own money and is not fundamentally or materially subject to claims from others).

In an embodiment, however, regulatory requirements may not permit a fully individual insurance investment product. Instead some, or all, of the product may need to be joined with similarly risked entities as part of a risk pool. But matching the insured entity to similarly risked entities is very challenging. In an embodiment, a suitable ML model can be trained to infer a match between an insured entity and a risk pool based on characteristics of the entity and the other entities in the pool. Further, the individual insurance investment product can be customized to allot a portion of the funds to an individual product and a portion to a pooled product (e.g., based on regulatory requirements).

Similarly, matching an insured entity to suitable investments is also a significant challenge. In an embodiment, another suitable ML model can be trained to infer a match between an insured entity and a suitable investment product, based on characteristics and preferences of the insured entity (e.g., risk tolerance preferences). And blockchain technology can be used to record and verify ownership of a product by an entity. This allows for distributed, public, access to an immutable record of ownership, protecting against fraud and misuse.

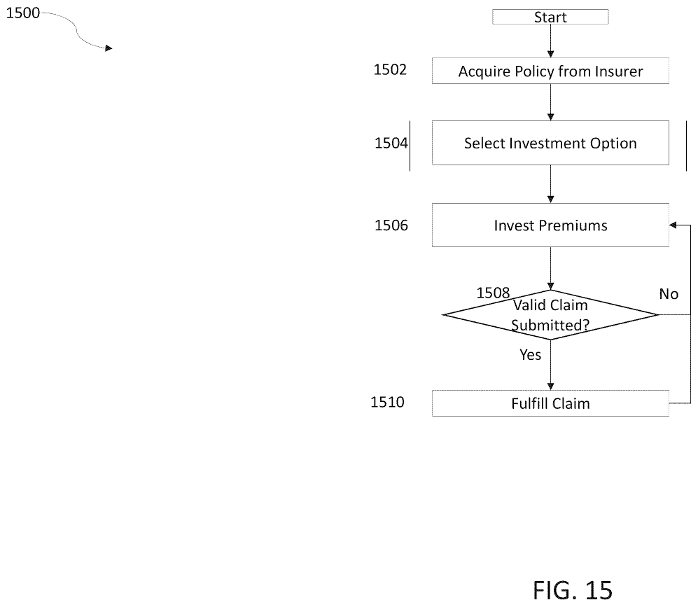

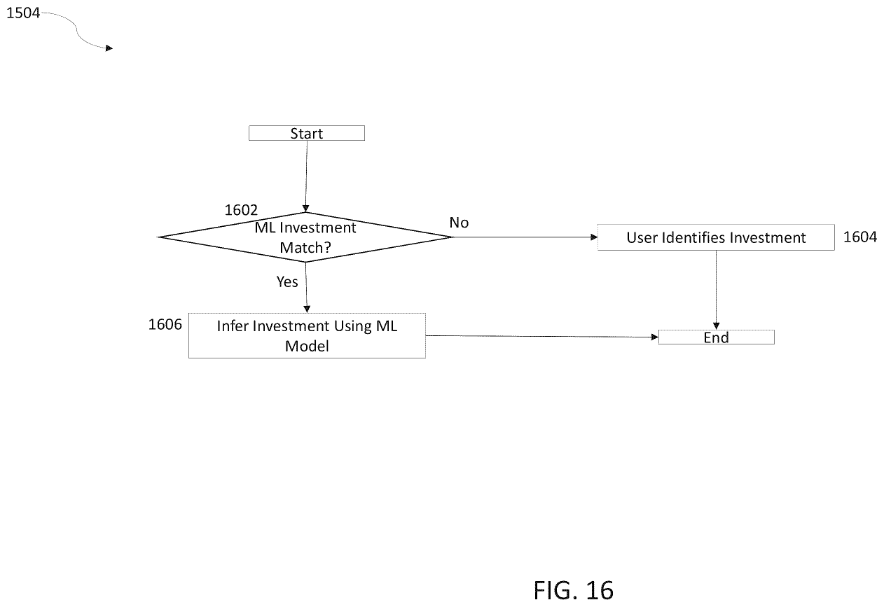

Further, regulatory requirements or other circumstances may lead an insured entity to acquire a modified insurance policy, referred to herein as a back-to-back insurance product, instead of (or in addition to) an individual insurance investment product. For example, an insured entity could contract with an insurer to acquire an insurance policy (e.g., a traditional insurance policy) and fund the policy with premiums (e.g., an up-front premium). The insurer could then purchase an investment product for the insured entity (e.g., based on the insured entity's preferences or choices). The insurer would invest the premium, and use the funds (e.g., the initial deposited premium amount and any investment earnings) to fund claims by the insured entity. In an embodiment, as discussed above, a suitable ML model could be trained to infer a match between the insured and the investment product (e.g., based on characteristics and preferences of the insured entity). In an embodiment, the insured could be permitted to redeem proceeds based on suitable rules or regulations. This is discussed further, below, with regard to FIGS. 15-16.

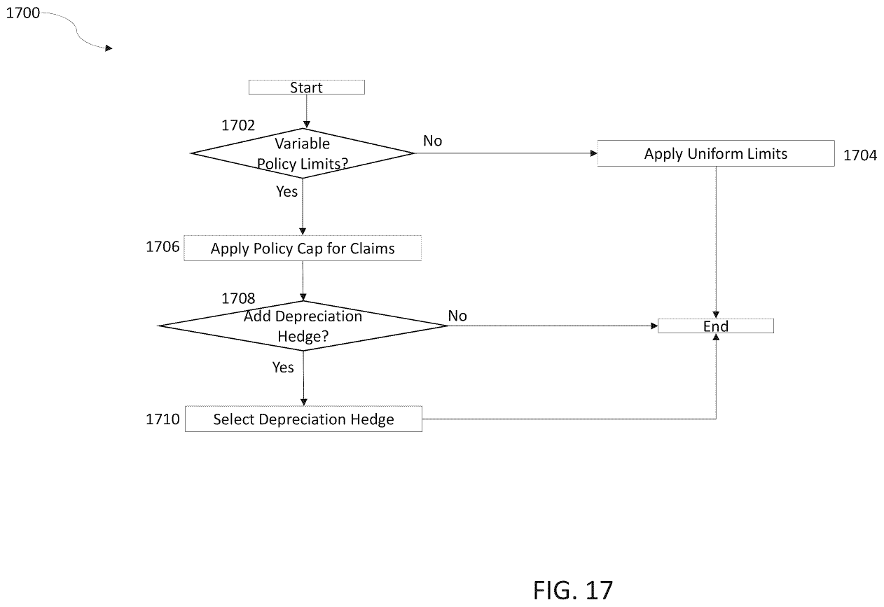

In an embodiment, a back-to-back insurance product (or any other suitable insurance product, including an individual insurance investment product as discussed above) can also include variable policy limits (VPL). As discussed above, a given insured entity may need to join insurance products with similarly risked entities as part of a risk pool. But the various entities may have different policy limits within the pool. In an embodiment, the insurance coverage for the various entities within the pool can be capped on a variable basis, based on the respective policy limits. For example, one insured entity could have $100,000 in coverage, another entity could have $1,000,000 in coverage, and another could have $10,000,000 in coverage. The respective insured entities would be permitted to fulfill claims up to their respective capped values in coverage. This is discussed further, below, with regard to FIG. 17.

In an embodiment, the coverage amount is based on the value of a corresponding investment, for the insured entity, based on the premium paid. For example, an insured entity submitting a $100,000 premium with $10,000 of investment appreciation (e.g., gain) could be entitled to $110,000 in coverage, while an insured entity with a $100,000 premium with $10,000 of investment depreciation (e.g., loss) could be entitled to $90,000 in coverage. The respective policy limit for each entity in the risk pool could be tied to the value of the backed investment account. Further, to avoid insufficient coverage should the premium investment depreciate, an insured could maintain a depreciation hedge (e.g., a put option or other hedge on the premium investment).

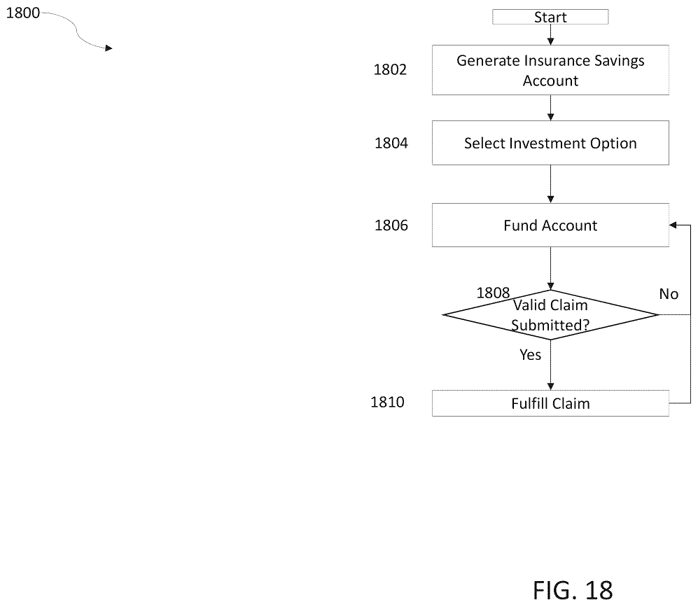

In an embodiment, in addition to or instead of any of the options described above, an entity could acquire an insurance savings account (e.g., a self-directed insurance savings account). For example, an entity could invest insurance premium funds in an insurance savings account instead of, or in addition to, acquiring another insurance product. The insured could then redeem funds from the insurance savings account to fulfill an insurance claim. This is discussed further, below, with regard to FIG. 18.

As discussed below, in an embodiment an individual insurance investment product, or another suitable insurance product, could be used to fully fund a wide variety of insurance policies. For entities with the financial resources to fund such a product, from the start, this is beneficial. But many entities do not have the resources to fully fund an insurance policy up front. Instead, these entities could use an individual insurance investment product to supplement a traditional policy.

For example, a traditional property insurance policy could have a large deductible, which would itself be a financial challenge to an individual in the event of a claim. The individual could purchase an individual insurance investment product to fund just this deductible, requiring funding only of the deductible amount and not the full value of the insured property (e.g., funding of a $5,000 deductible instead of a $100,000 property replacement cost). Further, the insured could increase the deductible on their traditional insurance policy, potentially significantly reducing premiums, and purchase an individual insurance investment product to insure only the deductible amount. Property insurance is merely one example, and these techniques can apply to any suitable insurance (e.g., health insurance, dental insurance, vehicle insurance (e.g., automobile insurance, motorcycle insurance, boat insurance, personal watercraft insurance, aircraft insurance, or any other suitable vehicle insurance), personal injury insurance, or any other suitable insurance).

Thus, aspects described herein provide significant advantages compared to conventional approaches for insurance policies. For example, matching a potential insured entity to similarly risked entities, and matching a potential insured entity to investment options, using a respective trained ML model, provides for an accurate match while minimizing the needed computational resources for the prediction and shifting the computational burden from prediction time (e.g., when near real-time response may be needed) to an earlier training time (e.g., when resources can be easily dedicated to the training). In an embodiment, matching using a specific rubric or algorithm with pre-defined rules can be computationally expensive, because a very large number of rules are needed and parsing and following the rules is computationally expensive. Further, this computationally expensive analysis is done at the time the insurance product is generated, when a rapid response is likely to be needed (e.g., to provide rapid feedback to the potentially insured entity).

Matching automatically using a trained ML model, by contrast, is significantly less computationally expensive at the time the insurance product is generated. For example, the prediction ML model can be trained up-front during a training phase, when rapid response is not necessary and computational resources are readily available. The trained ML model can then be used to rapidly, and computationally relatively cheaply, predict a match. This provides a significant technical advantage over prior techniques by shifting the computational burden from the prediction time, when a rapid response is needed and computational resources may be engaged in other tasks, to a planned training time when a rapid response is not necessary and computational resources are available.

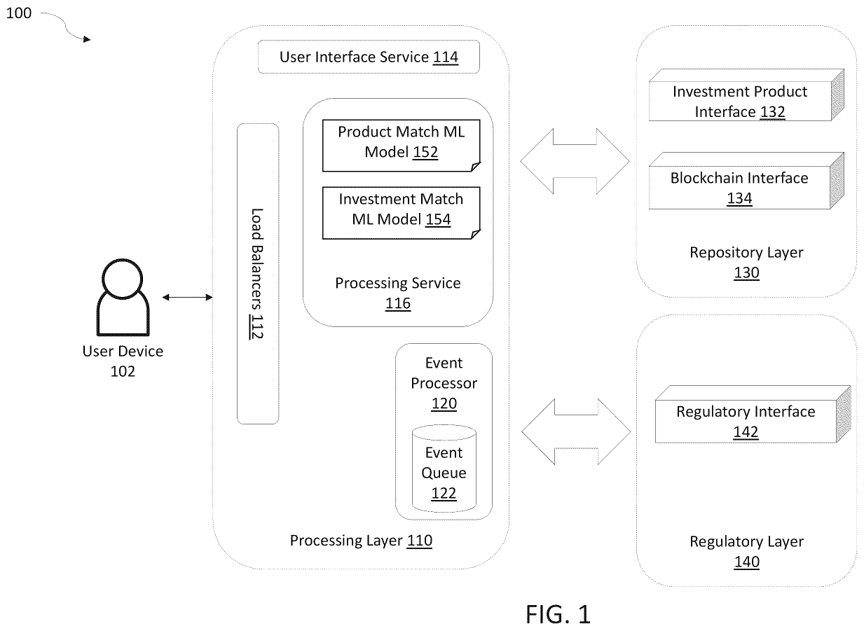

FIG. 1 depicts a computing environment 100 for an individual insurance investment product, according to one embodiment. In an embodiment, one or more user devices 102 interact with a processing layer 110. For example, the user devices 102 can include purchasers of individual insurance investment products or any other suitable insurance products (e.g., back-to-back insurance products), investment and insurance entities, third party auditors and regulators, and any other suitable user devices. The user devices 102 can be any suitable computing devices (e.g., laptop computers, desktop computers, smartphones, tablet computers, smart watches and wearable devices, embedded devices, and any other suitable computing devices) and interact with the processing layer 110 using a suitable communication network. For example, the user devices 102 can interact with the processing layer 110 using a local area network (LAN), a wide area network (WAN), the Internet, or any other suitable communication network. Further, the user devices 102 and processing layer 110 can be connected to the communication network using any suitable network connection, including a wired connection (e.g., an Ethernet or fiber optic connection), a wireless connection (e.g., a WiFi connection), a cellular connection, or any other suitable network connection.

In an embodiment, the processing layer 110 includes one or more load balancers 112 to manage connections with the user devices 102. For example, the processing layer 110 can be implemented using any suitable combination of physical compute systems, cloud compute nodes and storage locations, or any other suitable implementation. In this example, the load balancers 112 can manage connections between the user devices 102 and any compute nodes or compute systems used in the processing layer 110. For example, the processing layer 110 could be implemented using a server or cluster of servers, and the load balancers 112 can manage connections from the user devices 102 to the server or cluster of servers. As another example, the processing layer 110 can be implemented using a combination of compute nodes and storage locations in a suitable cloud environment, including a public cloud, a private cloud, a hybrid cloud, or any other suitable implementation.

The processing layer 110 further includes a user interface service 114. In an embodiment, the user interface service 114 facilitates providing a user interface for generating an individual insurance investment product, fulfilling an individual insurance investment product claim, or both. For example, the user interface service 114 can provide a suitable web interface for the user device 102 to access via a web browser, can facilitate a mobile application user interface (e.g., for a smartphone, tablet, wearable device, laptop computer, or desktop computer), or can facilitate any other suitable user interface. As discussed above and below with regard to FIGS. 15-18, an individual insurance investment product is merely one example of a suitable insurance product and the processing layer and other aspects of FIG. 1 can be used for any suitable insurance product (e.g., a back-to-back insurance product, an insurance savings account, or any other suitable insurance product).

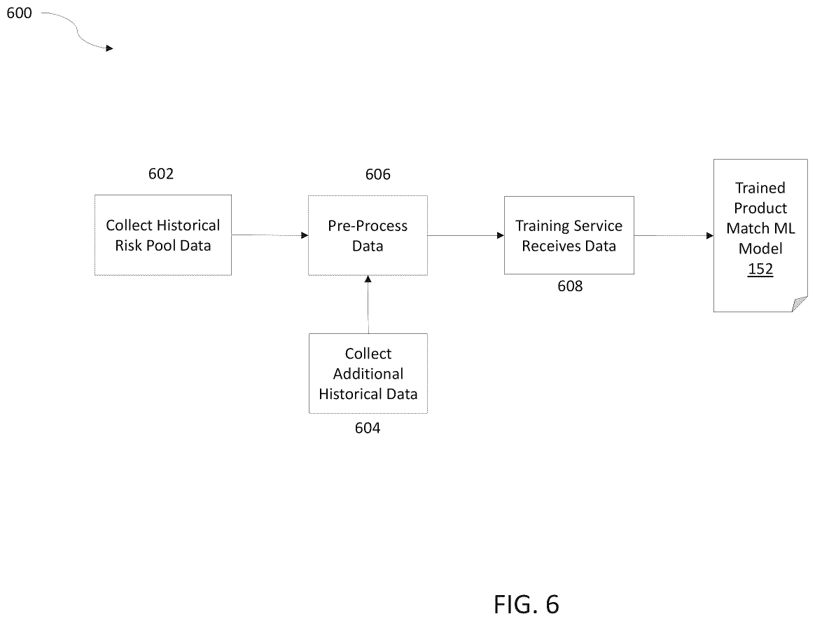

The processing layer 110 further includes a processing service 116. In an embodiment, the processing service 116 facilitates generating an individual insurance investment product, fulfilling an individual insurance investment product claim, or both. For example, the processing service 116 can include a product match ML model 152 to facilitate inferring a match between a user and a risk pool when generating an individual insurance investment product, an investment match ML model 154 to facilitate inferring investment characteristics or options for a given user, and any other suitable ML techniques. The product match ML model 152 and investment match ML model 154 can be any suitable ML models. For example, the product match ML model 152 and investment match ML model 154 can be supervised ML models (e.g., deep learning neural networks (DNNs)) trained to predict a product or investment match, respectively. Training and inference for the product match ML model 152 and investment match ML model 154 are discussed further, below, with regard to FIGS. 6-7 and 9-10.

The processing layer 110 further includes an event processor 120, which includes an event queue 122. In an embodiment, the processing layer 110 interacts with external entities using a repository layer 130 and a regulatory layer 140. For example, the processing layer 110 can create an event for each transaction (e.g., generating an individual insurance investment product, fulfilling an individual insurance investment product claim, or any other suitable transaction). These events can be stored in the event queue 122, and processed using the event processor 120 (e.g., a software application, as described further below). The event queue 122 can be any suitable repository, including dynamic or persistent memory, and can store the events in any suitable manner. As discussed above and below with regard to FIGS. 15-18, an individual insurance investment product is merely one example of a suitable insurance product, and the processing layer 110 and other aspects of FIG. 1 can be used for any suitable insurance product (e.g., a back-to-back insurance product, an insurance savings account, or any other suitable insurance product).

In an embodiment, the processing layer 110 interacts with a repository layer 130 to record and retrieve individual insurance investment products. For example, the repository layer 130 includes an investment product interface 132. In an embodiment, the investment product interface 132 provides access to investment products maintained by third parties, the creator of the individual insurance investment products, or any other entity. For example, the investment product interface 132 can make use of a suitable application programming interface (API) to access investment products maintained by third parties or can interact with a suitable electronic repository recording information about investment products (e.g., an electronic database using suitable queries), among other options.

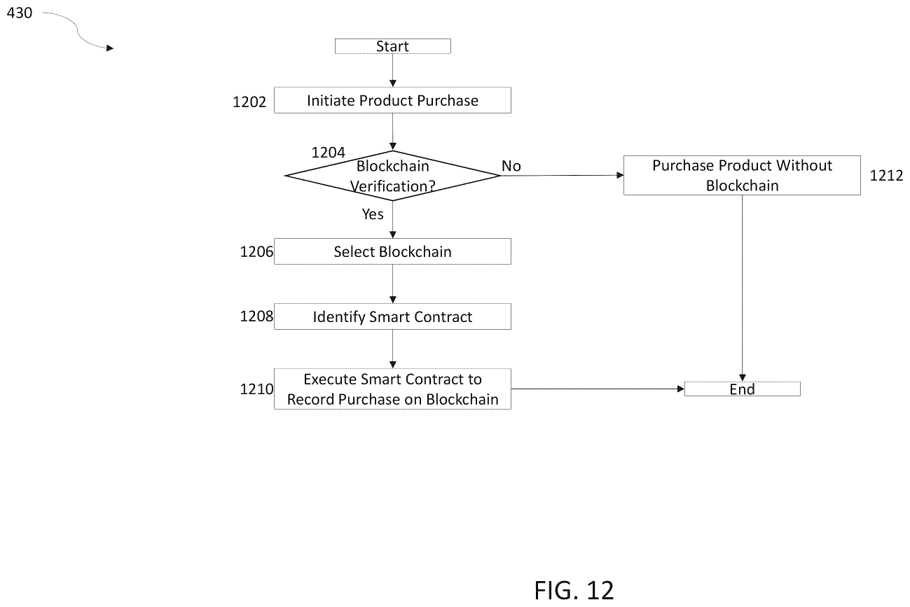

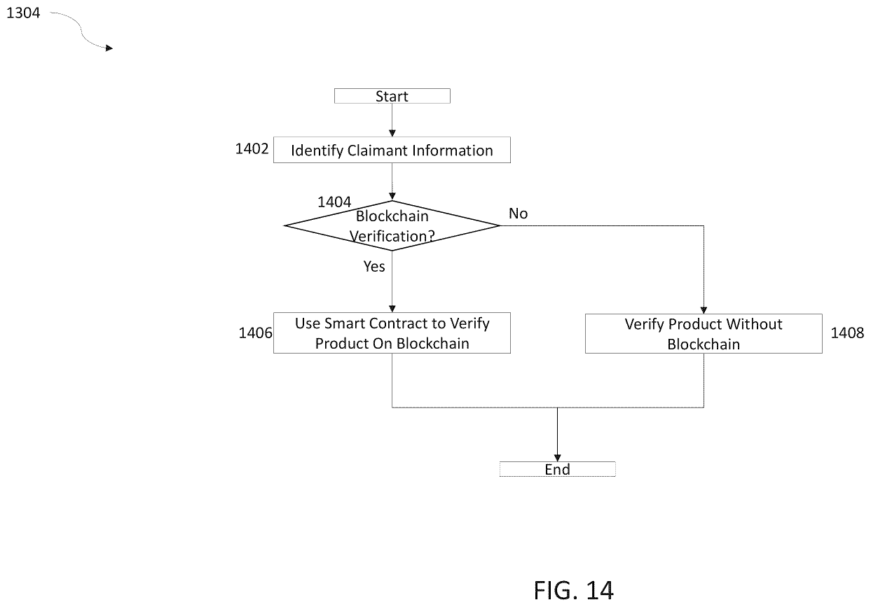

The repository layer 130 further includes a blockchain interface 134. In an embodiment, the processing layer 110 uses a blockchain to record and verify individual insurance investment products. This is discussed further, below, with regard to FIGS. 12 and 14. For example, the processing layer 110 (e.g., a suitable software service in the processing layer 110) can interact with a block chain by making a remote procedure call (RPC) to the blockchain interface 134. In an embodiment, the processing layer 110 interacts with independently operating blockchains using the blockchain interface 134. The blockchain interface 134 can access any suitable blockchain (e.g., Ethereum, Polygon, Klatyn, Solana, and any other suitable blockchain) and includes any number of blockchain interfaces.

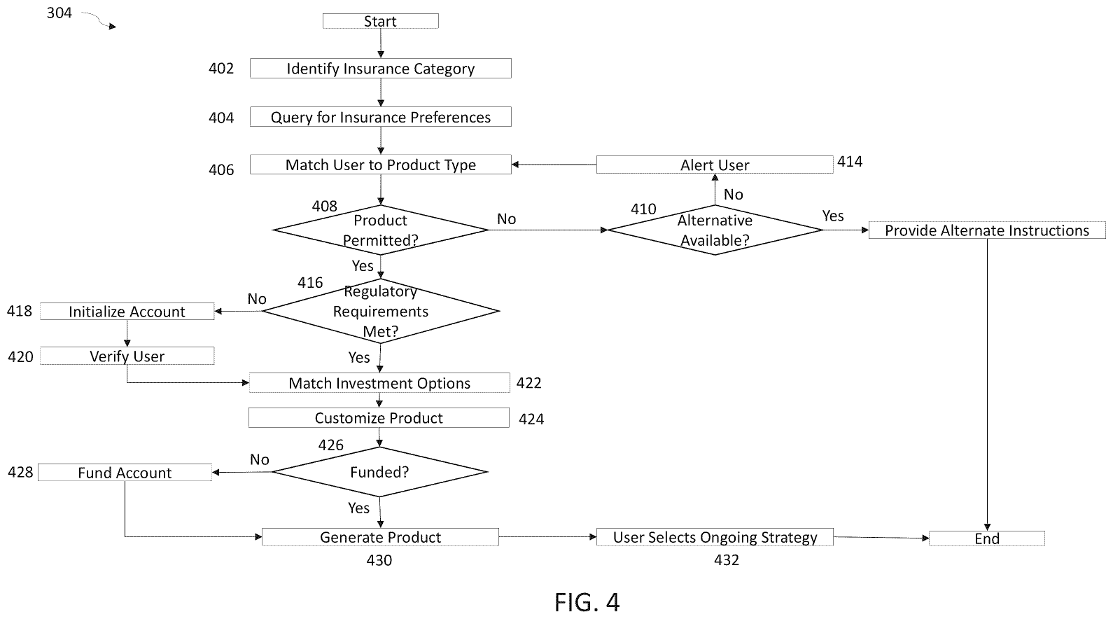

In an embodiment, the processing layer 110 further interacts with a regulatory layer 140 using a regulatory interface 142. For example, the regulatory layer 140 can facilitate identifying regulatory requirements for an individual insurance investment product (e.g., based on user characteristics and jurisdiction). The regulatory layer 140 can further facilitate verifying that a given individual insurance investment product meets expected regulatory requirement, or can facilitate any other suitable functionality. This is discussed further, below, with regard to FIG. 4. In an embodiment, the regulatory interface 142 provides a suitable API for the processing layer 110 to interact with third party regulatory systems, electronic repositories, or both.

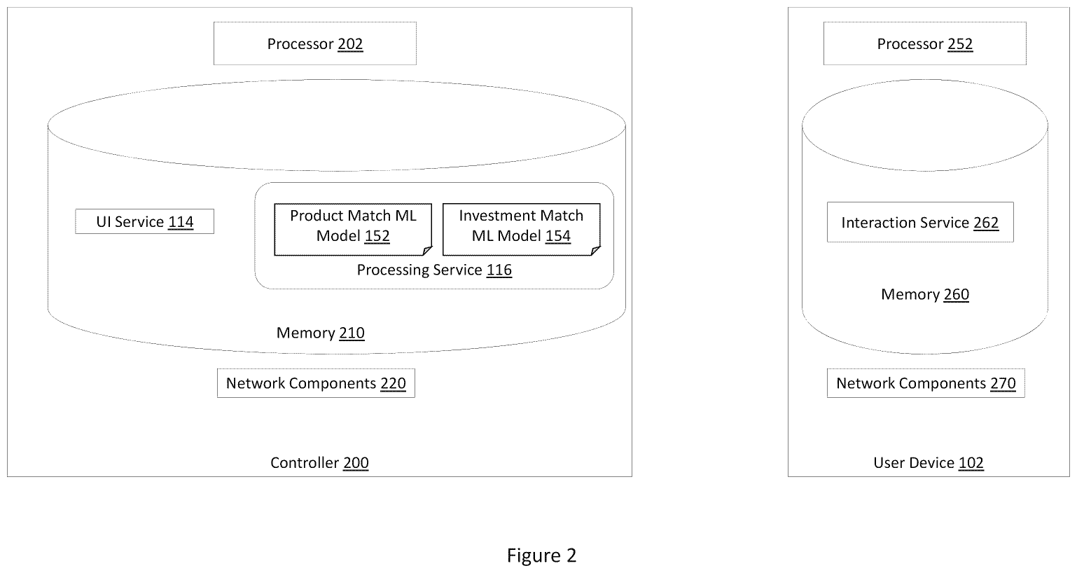

FIG. 2 depicts a block diagram for a controller 200 and a user device 102 for an individual insurance investment product according to one embodiment. In an embodiment, the controller 200 corresponds with one or more aspects of the processing layer 110 illustrated in FIG. 1. The controller 200 includes a processor 202, a memory 210, and network components 220. The memory 210 may take the form of any non-transitory computer-readable medium. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the controller 200 to interface with a suitable communication network (e.g., a communication network interconnecting various components of the computing environment 100 illustrated in FIG. 1, or interconnecting the computing environment 100 with other computing systems). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

The memory 210 generally includes program code for performing various functions related to use of the controller 200. The program code is generally described as various functional “applications” or “modules” within the memory 210, although alternate implementations may have different functions and/or combinations of functions.

As discussed above in relation to FIG. 1, within the memory 210 the UI service 114 facilitates providing a user interface for generating an individual insurance investment product, fulfilling an individual insurance investment product claim, or both. The processing service 116 facilitates generating an individual insurance investment product, fulfilling an individual insurance investment product claim, or both. The product match ML model 152 facilitates inferring a match between a user and a risk pool when generating an individual insurance investment product, and the investment match ML model 154 facilitates inferring investment characteristics or options for a given user. In an embodiment, the product match ML model 152 and investment match ML model 154 can be any suitable ML models. Further, these are merely examples, and the memory 210 can include any suitable functionality (including ML related functionality).

As discussed above, in an embodiment the user device 102 can be any suitable computing device, including a laptop computer, desktop computer, smartphone, tablet computer, smart watch or wearable device, embedded device, and any other suitable computing device. The user device 102 includes a processor 252, a memory 260, and network components 270. The memory 260 may take the form of any non-transitory computer-readable medium. The processor 252 generally retrieves and executes programming instructions stored in the memory 260. The processor 252 is representative of a single central processing unit (CPU), multiple CPUs, a single CPU having multiple processing cores, graphics processing units (GPUs) having multiple execution paths, and the like.

The network components 270 include the components necessary for the user device 102 to interface with a suitable communication network (e.g., a communication network interconnecting various components of the computing environment 100 illustrated in FIG. 1, or interconnecting the computing environment 100 with other computing systems). For example, the network components 270 can include wired, WiFi, or cellular network interface components and associated software. Although the memory 260 is shown as a single entity, the memory 210 may include one or more memory devices having blocks of memory associated with physical addresses, such as random access memory (RAM), read only memory (ROM), flash memory, or other types of volatile and/or non-volatile memory.

The memory 260 generally includes program code for performing various functions related to use of the user device 102. The program code is generally described as various functional “applications” or “modules” within the memory 260, although alternate implementations may have different functions and/or combinations of functions. Within the memory 260 the interaction service 262 facilitates user device interaction for generating an individual insurance investment product, fulfilling an individual insurance investment product claim, or both (e.g., interaction with a user interface).

As discussed above in relation to the processing layer 110 illustrated in FIG. 1, while the controller 200 and user device 102 are each illustrated as a single entity, in an embodiment, the various components can be implemented using any suitable combination of physical compute systems, cloud compute nodes and storage locations, or any other suitable implementation. For example, the controller 200 could be implemented using a server or cluster of servers. As another example, the controller 200 can be implemented using a combination of compute nodes and storage locations in a suitable cloud environment. For example, one or more of the components of the controller 200 can be implemented using a public cloud, a private cloud, a hybrid cloud, or any other suitable implementation.

Although FIG. 2 depicts the services 114 and 116, and the ML models 152 and 154, as being mutually co-located in memory 210, and the service 262 as located in the memory 260, that representation is also merely provided as an illustration for clarity. More generally, the controller 200, the user device 102, or both, may include one or more computing platforms, such as computer servers for example, which may be co-located, or may form an interactively linked but distributed system, such as a cloud-based system. As a result, processors 202 and 252 and memories 210 and 260 may correspond to distributed processor and memory resources within the computing environment 100. Thus, it is to be understood that any, or all, of the services 114, 116, and 262, and the ML models 152 and 154, may be stored remotely from one another within the distributed memory resources of the computing environment 100. Further, as discussed above and below with regard to FIGS. 15-18, an individual insurance investment product is merely one example of a suitable insurance product, and the controller 200 and other aspects of FIG. 2 can be used for any suitable insurance product (e.g., a back-to-back insurance product, an insurance savings account, or any other suitable insurance product).

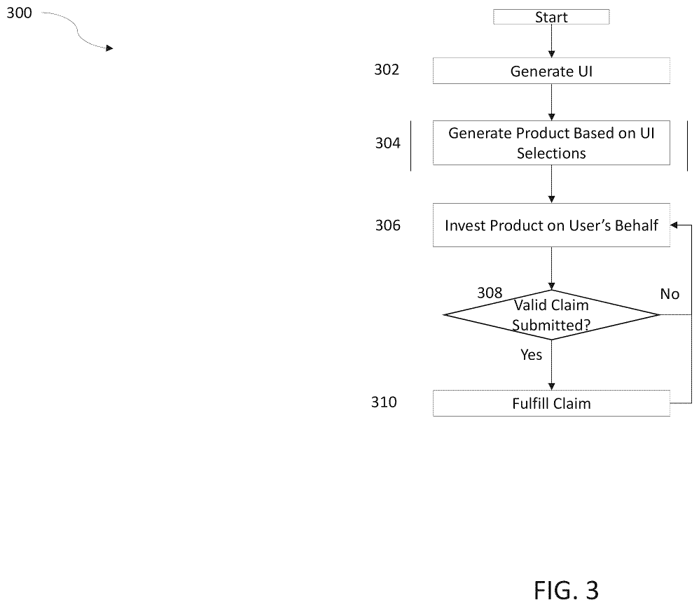

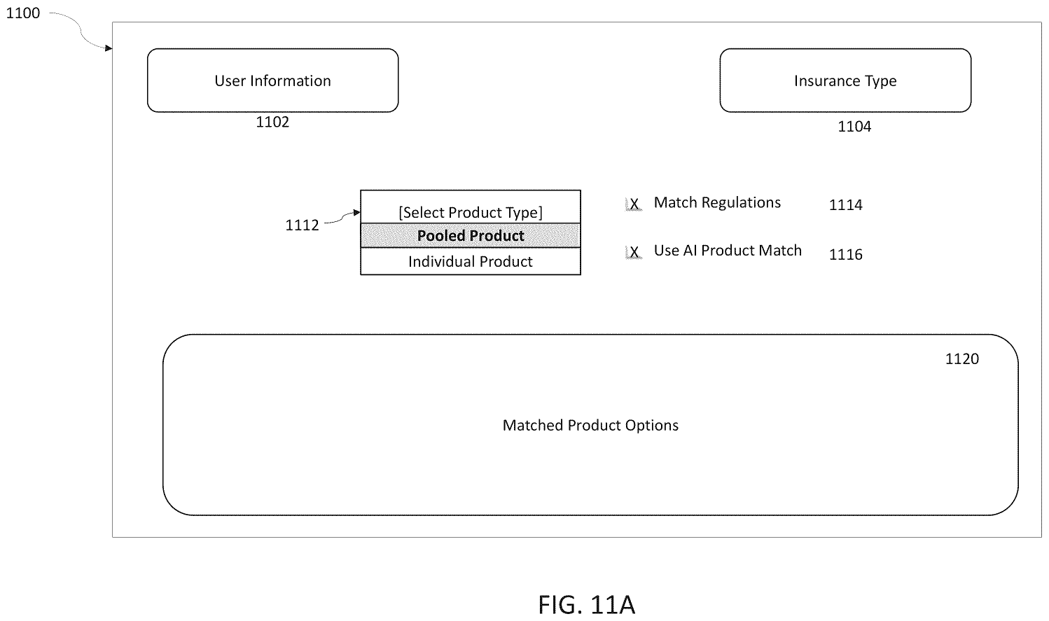

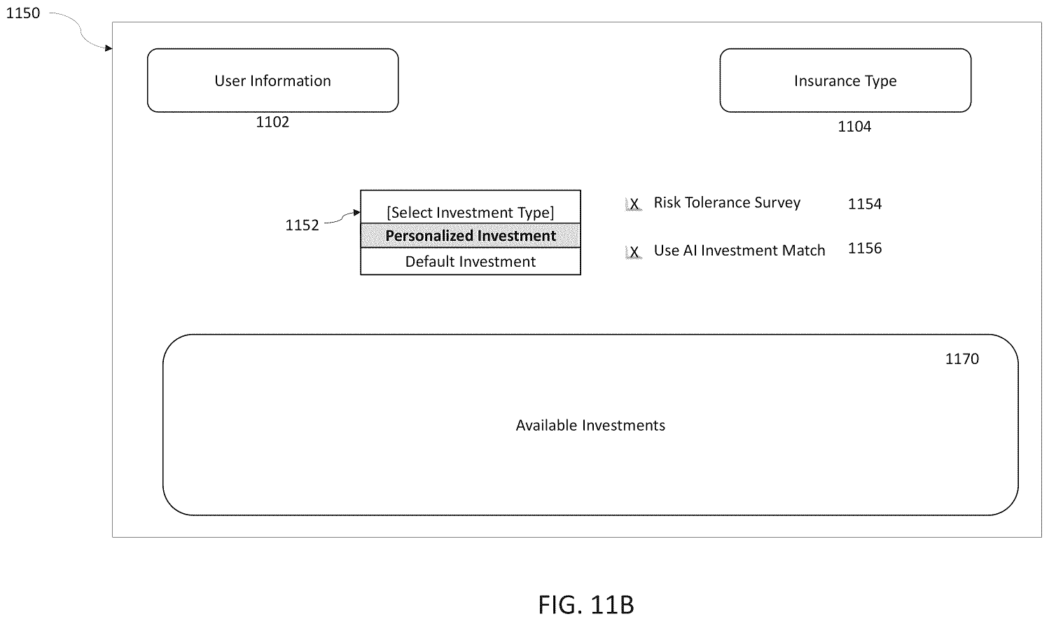

FIG. 3 is a flowchart 300 illustrating generating and fulfilling an individual insurance investment product, according to one embodiment. At block 302 a UI service (e.g., the UI service 114 illustrated in FIGS. 1-2) generates a user interface for creating an individual insurance investment product. For example, the user interface can allow a user to identify insurance and investment preferences and requirements, match a user to a predicted preferred product type (e.g., using ML), identify whether regulatory requirements are met, match a user to investment options, allow a user to customize a product, and complete purchase of the product for the user, among other features. This is discussed further, below, with regard to FIG. 4. Further, examples of the user interface are illustrated at FIGS. 11A-C and 14, below.

In an embodiment, the UI service provides the user interface to a user device (e.g., the user device 102 illustrated in FIGS. 1-2). For example, the UI service can generate a suitable web interface, mobile application interface, desktop application interface, or any other suitable interface, and can provide the interface to the user device. The UI service can transmit the user interface to the user device using a suitable communication network and any suitable communication technique, as discussed above in relation to FIG. 1.

At block 304, a processing service (e.g., the processing service 116 illustrated in FIGS. 1-2) generates an individual insurance product based on user interface selections. For example, the processing service can use a suitable ML model (e.g., the product match ML model 152 illustrated in FIGS. 1-2) to match a user to an individual insurance product (e.g., based on a risk pool), and can create that product using selections made by the user in the user interface. As another example, the processing service can select investment options for the product based on matching the user to investments using a suitable ML model (e.g., the investment match ML model 154 illustrated in FIGS. 1-2) and selections made by the user in the user interface. This is discussed further, below, with regard to FIGS. 4-12. These are merely examples, and the processing service can generate the individual insurance product without one, or both, of the ML models, or using any other suitable technique.

At block 306, the processing service invests the product on the user's behalf. In an embodiment, as discussed above, the processing service can interact with an investment product interface (e.g., the investment product interface 132 illustrated in FIG. 1) to invest the individual insurance investment product. For example, the processing service can interact with a third party investment entity to invest the user funds, as preferred by the user (e.g., based on selections to the user interface as discussed above in relation to block 304).

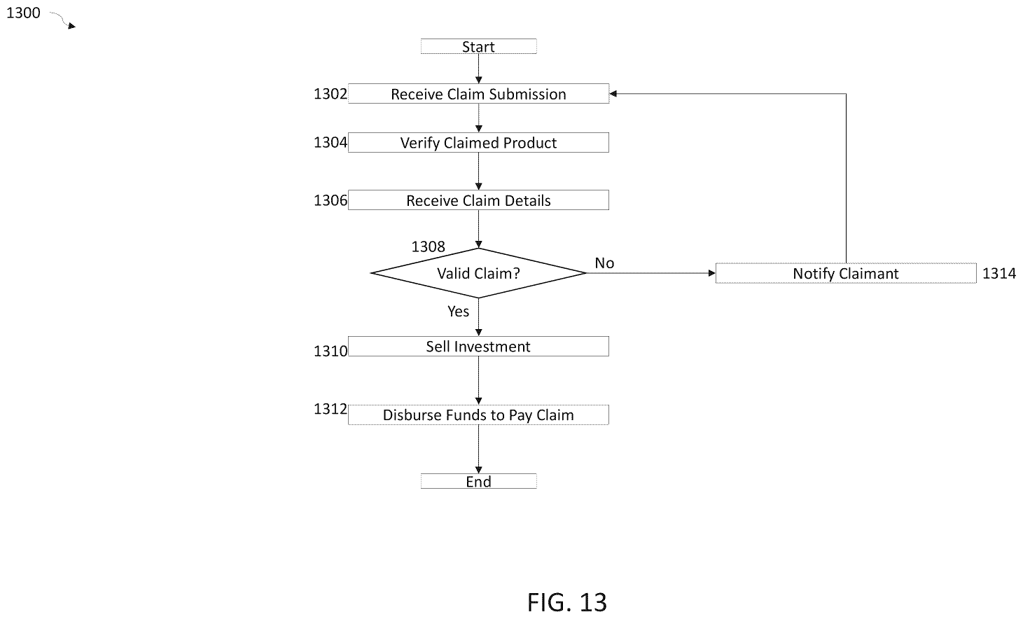

At block 308, the processing service determines whether a valid claim is submitted. For example, after the individual insurance investment product has been created, the UI service (or any other suitable software service) can generate a user interface to allow a user to submit a claim against the product. The processing service can verify whether the claim is valid. This is discussed further, below, with regard to FIGS. 13-14. If the claim is valid, the flow proceeds to block 310. If not, the flow returns to block 306 and the product continues to be invested.

At block 310, the processing service fulfills the claim. For example, assuming the claim is valid, the processing service can pay the claim out of the funds in the individual insurance investment product. This is discussed further, below, with regard to FIG. 13.

FIG. 4 is a flowchart illustrating generating an individual insurance investment product, according to one embodiment. In an embodiment, FIG. 4 corresponds with block 304 illustrated in FIG. 3. At block 402, a processing service (e.g., the processing service 116 illustrated in FIGS. 1-2) identifies an insurance category. In an embodiment, a user can select an individual insurance investment product for a variety of different insurance types. For example, the individual insurance investment product can provide property insurance (e.g., homeowners insurance, renters insurance, commercial property insurance, personal property insurance, or any other suitable property insurance), health insurance, dental insurance, vehicle insurance (e.g., automobile insurance, motorcycle insurance, boat insurance, personal watercraft insurance, aircraft insurance, or any other suitable vehicle insurance), personal injury insurance, or any other suitable insurance. In an embodiment, a user selects the preferred insurance type using a suitable user interface and a user device (e.g., the user device 102 illustrated in FIGS. 1-2), and the processing service receives the selection (e.g., through a suitable communication network).

At block 404, the processing service queries for insurance preferences. In an embodiment, the processing service can use a suitable user interface to query the user for desired types of coverage and coverage. For example, if the user selects property insurance the user interface can query the user for the desired types of coverage (e.g., fire coverage, wind coverage, flood coverage, or any other suitable option). As another example, if the user selects health insurance the interface can query the user for the desired insurance preferences (e.g., deductibles, co-pays, in-network and out-of-network costs or variances, or any other suitable preferences). These are merely examples. In an embodiment, the user interface provides an option for the user to elect all types of coverage permitted under law. Because the individual insurance product is funded by the user, electing the broadest possible coverage is likely to be the most common user preference.

At block 406, the processing service matches the user to a product type. In an embodiment, the individual insurance investment product relates to a single entity. For example, the individual insurance investment product can be funded by a single entity, and can be claimed (in suitable circumstances) by that entity. Alternatively, or in addition, the individual insurance investment product is part of a pooled collection of products for multiple entities. For example, state or federal rules or regulations may require the product to relate to pooled risk among a group of entities.

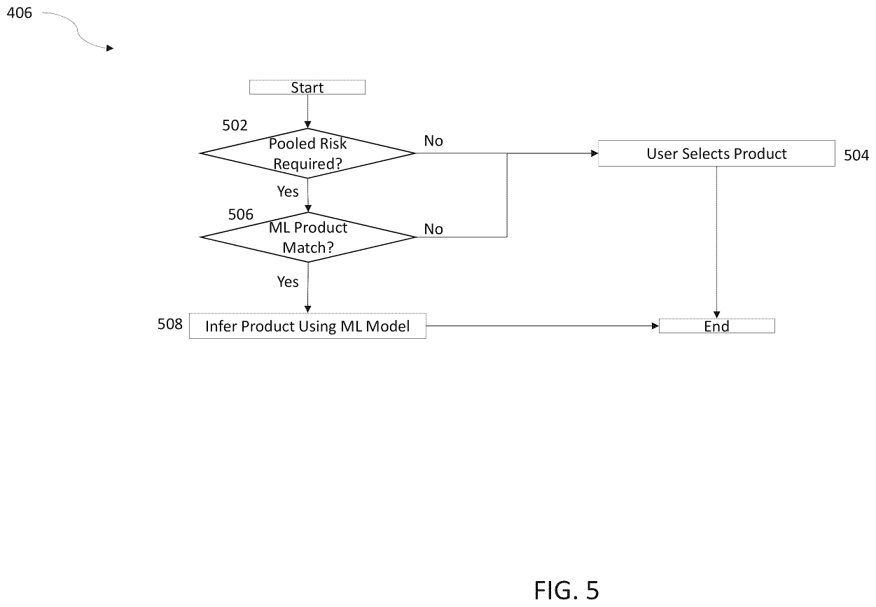

In an embodiment, the processing service matches the user to an individual product, or a pooled product. Further, if the product is pooled, the processing service matches the user to similarly risked policy holders to form the pool. In an embodiment, a suitable ML model (e.g., the product match ML model 152 illustrated in FIG. 2) assists by inferring a predicted product for the user. This is discussed further, below, with regard to FIG. 5. In an embodiment, the processing service can further customize the product to be partially individual, and partially pooled. This is also discussed further, below, with regard to block 424.

At block 408, the processing service determines whether the product is permitted. In an embodiment, laws and regulations can vary by jurisdiction. For example, one jurisdiction (e.g., one state) may permit individual insurance investment products with minimal restrictions. Another jurisdiction (e.g., a different state) may require risk pooling, or impose other requirements. If the product is permitted, the flow proceeds to block 416, discussed below. If the product is not permitted, the flow proceeds to block 410.

At block 410 the processing service determines whether an alternative is available. For example, jurisdictional rules may be applied based on place of purchase, location of insured item, or other criteria. If the processing service determines that the desired product is not currently permitted (e.g., at block 408), but an alternative solution is available, the flow proceeds to block 410. For example, the user may be located in a jurisdiction (e.g., a state) where the user is not permitted to purchase the desired product. But a nearby jurisdiction (e.g., a nearby state) may permit purchase. The processing service could identify this alternative solution. This is merely an example, and any suitable criteria and alternatives could be used.

At block 412, the processing service provides alternate instructions. For example, assume the product is not permitted in the user's current location but is permitted in a nearby location. The processing service can modify a user interface to provide instructions that will allow the product purchase (e.g., textual instructions, video instructions, audio instructions, or any other suitable instructions).

Returning to block 410, if no alternative is available, the flow proceeds to block 414. At block 414 the processing service alerts the user that the product is not permitted. In an embodiment, this allows the user to return to the user interface to select a different product. For example, the flow can return to block 406 and match the user to a different product. This is merely an example, and the flow could instead end or proceed to any other suitable block.

Returning to block 408, if the product is permitted the flow proceeds to block 416. At block 416, the processing service determines whether regulatory requirements are met. In an embodiment, jurisdictions that allow the desired product may have varied regulatory requirements to actually purchase the product. For example, some jurisdictions may require a user to open a separate account associated with the product (e.g., an insurance account at a brokerage). As another example, different jurisdictions may have different customer verification (e.g., know your customer (KYC)) requirements.

In an embodiment, the processing service interacts with a suitable third party system (e.g., the regulatory layer 140 illustrated in FIG. 1) using a suitable interface (e.g., the regulatory interface 142 illustrated in FIG. 1) to determine whether regulatory requirements are met. This is merely an example, and the processing service can instead, itself, identify whether regulatory requirements are met (e.g., using a suitable electronic repository) or can use any other suitable technique. If regulatory requirements are not met, the flow proceeds to block 418.

At block 418, the processing service initializes an account. For example, as discussed above, regulatory requirements for a particular jurisdiction may require a user to open a separate account (e.g., an insurance account at a brokerage). The processing service can initialize the account at block 418.

At block 420, the processing service verifies a user. For example, as discussed above, different jurisdictions may have different user verification (e.g., KYC) requirements. The processing service can fulfil these requirements.

Opening a separate account, and user verification, are merely examples of suitable regulatory requirements. In an embodiment, the processing service takes any suitable steps to meet the regulatory requirements (e.g., reporting requirements, purchase requirements, verification requirements, or any other suitable requirements. The flow then proceeds to block 422.

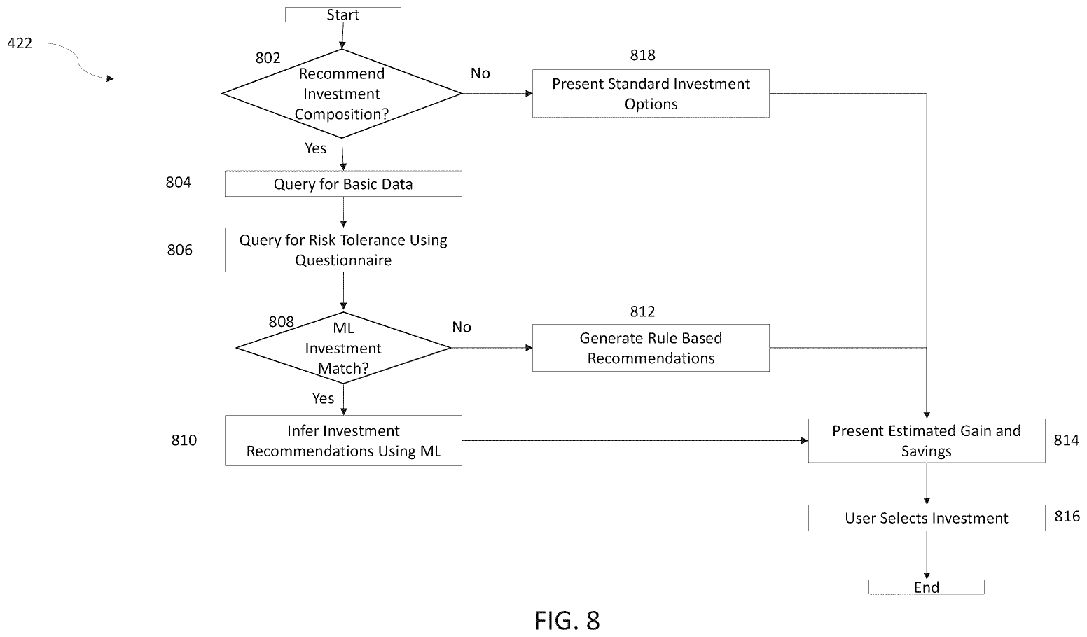

At block 422, the processing service matches the user to investment options for the desired product. In an embodiment, users can select investment options based on a wide variety of investment preferences. For example, the user can be queried for risk tolerance (e.g., using a suitable questionnaire) and can be provided with estimated gains and savings for various investment options. These can be used to match the user to an investment option. In an embodiment, a suitable ML model (e.g., the investment match ML model 154 illustrated in FIGS. 1-2) infers a predicted suitable investment match for the user. This is discussed further, below, with regard to FIG. 8.

At block 424, the processing service customizes the product. As discussed above in relation to block 406, in an embodiment the individual insurance product can be individual (e.g., tied to a particular claimant entity) or pooled (e.g., part of a pool of similarly risked entities). In addition, the processing service can create a customized (e.g., blended) product that is partially individual and partially pooled. For example, regulatory requirements could require that a certain percentage, or monetary fraction, of the product be tied to a risk pool (e.g., 90% individual and 10% pooled). The processing service could customize the product to meet the requirements, allotting the permitted individual portion for accumulation on behalf of only the purchasing entity, and the remainder as part of a pool of multiple entities. In an embodiment, the processing service can identify the regulatory requirements dynamically (e.g., using the regulatory interface 142 illustrated in FIG. 1). Alternatively, or in addition, the processing service could be statically configured with requirements for each suitable jurisdiction.

At block 426, the processing service determines whether the product is funded. For example, the user may already maintain an account with funds to be used for the product. If the product is funded, the flow proceeds to block 430. If the product is not funded, the flow proceeds to block 428, where the user funds the account, and then to block 430. In an embodiment, the processing service can allow the user to use any suitable account or technique to fund the account.

At block 430, the processing service generates the product. For example, the processing service uses the funds to purchase the individual insurance investment product. This is discussed further, below, with regard to FIG. 12. In an embodiment, the processing service uses a blockchain smart contract (e.g., a software program maintained in a blockchain) to generate and record the product (e.g., using the blockchain interface 134 illustrated in FIG. 1). Alternatively, the processing service generates the product without using a blockchain and records the product in another suitable electronic repository (e.g., using another aspect of the repository layer 130 illustrated in FIG. 1).

At block 432, the processing service allows the user to select the ongoing strategy. In an embodiment, various additional investment options are available once the product is purchased. For example, the user can choose whether to reinvest dividend distributions. This is merely one example, and the processing service can allow the user to select any aspect of ongoing strategy. Further, in an embodiment, the user can select all suitable aspects of investment strategy before purchasing the product (e.g., at blocks 422 and 424 discussed above).

While FIG. 4 focuses on an individual insurance investment product, as discussed above, this is merely on example of a suitable insurance product. In an embodiment, one or more of these techniques can be applied to an insurance savings product. For example, a user could fund a property savings account, similar to a health savings account (HSA). The property savings account could allow the user to save and invest funds (e.g., in a tax-advantaged way) to pay expenses related to property damage or property insurance claims. For example, the property savings account could be applied to property insurance deductibles, or any other suitable out-of-pocket expense relating to property insurance or a property insurance claim. As another example, the property savings account could be used to fund various expenses related to property without an insurance claim (e.g., the property savings account could be used in place of property insurance). This is merely one example, and any suitable savings account could be used (e.g., for other types of insurance claims).

FIG. 5 is a flowchart illustrating matching a user to a product type for an individual insurance investment product, according to one embodiment. In an embodiment, FIG. 5 corresponds with block 406 illustrated in FIG. 4. At block 502, a processing service (e.g., the processing service 116 illustrated in FIGS. 1-2) determines whether pooled risk is required. As discussed above, in an embodiment, the individual insurance investment product relates to a single entity. For example, the individual insurance investment product can be funded by a single entity, and can be claimed (in suitable circumstances) by that entity. Alternatively, or in addition, the individual insurance investment product is part of a pooled collection of products for multiple entities. For example, state or federal rules or regulations may require the product to relate to pooled risk among a group of entities.

In an embodiment, the processing service queries a third party interface to determine whether pooled risk is required (e.g., the regulatory interface 142 illustrated in FIG. 2). For example, the processing service can use a suitable API or make a suitable RPC, providing relevant data (e.g., the jurisdiction, user information, and any other suitable data) and receiving a response indicating whether pooled risk is required. Alternatively, the processing service determines whether pooled risk is required without contacting a third party (e.g., based on a suitable electronic repository). As another alternative, whether pooled risk is required may be set for all users (e.g., pooled risk is always, or never, required). For example, jurisdictional rules or regulations may require pooled risk in all, or no, jurisdictions. If pooled risk is not required, the flow proceeds to block 504.

At block 504, the user selects a product. For example, a user interface service (e.g., the UI service 114 illustrated in FIGS. 1-2) can generate a suitable interface providing individual insurance investment product options. The user can select a suitable option, and the flow ends.

Returning to block 502, if pooled risk is required the flow proceeds to block 506. At block 506, the processing service determines whether to undertake an ML product match. In an embodiment, a suitable ML model (e.g., the product match ML model 152 illustrated in FIGS. 1-2) can infer a pooled risk product for the user. This can be an optional feature, such that the processing service can proceed to block 508 and infer the product using the ML model, or can proceed to block 504 and allows the user to select the product. If ML product match is used, the flow proceeds to block 508.

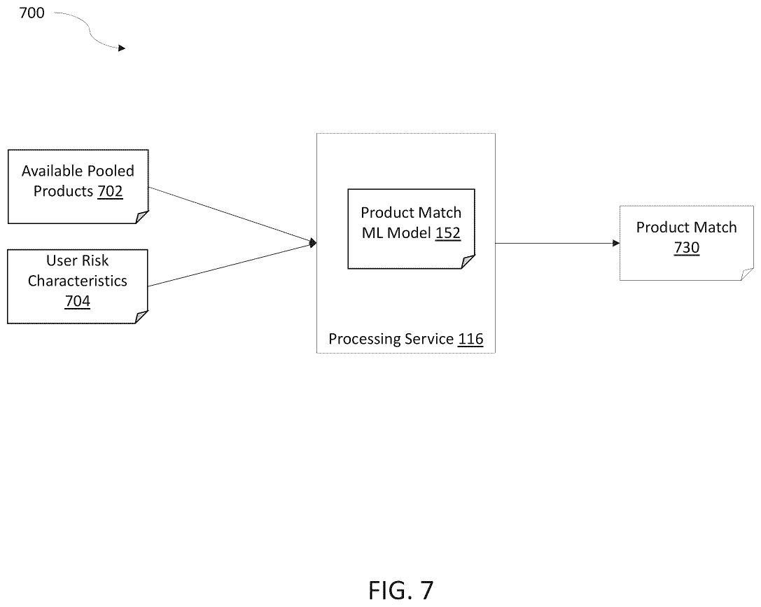

At block 508, the processing service infers the product match using an ML model. For example, the processing service can use the ML model to infer a pooled product with similarly risked policy holders, to the user. This is discussed further, below, with regard to FIGS. 6-7.

FIG. 6 is a flowchart 600 illustrating training a product match ML model, according to one embodiment. This is merely an example, and in an embodiment a suitable unsupervised technique could be used (e.g., without requiring training). At block 602, a training service (e.g., a human administrator or a software or hardware service) collects historical risk pool data. For example, a processing service (e.g., the processing service 116 illustrated in FIGS. 1-2) can be configured to act as a training service, and can collect historical data reflecting risk characteristics of users and insurance outcomes of users (e.g., gathered over time).

At block 606, the training service (or other suitable service) pre-processes the collected historical risk pool data. For example, the training service can create feature vectors reflecting the values of various features, for each risk pool relating to a prior user. At block 608, the training service receives the feature vectors and uses them to train a trained product match ML model 152.

In an embodiment, at block 604 the training service also collects additional historical data. For example, the training service can use prior claim data (e.g., data relating to prior claims for individual insurance products made by users), prior regulatory data (e.g., data reflecting prior regulatory success or failure of various individual insurance products), prior user feedback data (e.g., surveys and other suitable reflections of user feedback for prior individual insurance products), and any other suitable data At block 606, the training service can also pre-process this additional historical data. For example, the feature vectors corresponding to the historical insurance product data can be further annotated using the additional historical data. Alternatively, or in addition, additional feature vectors corresponding to the additional historical data can be created. At block 608, the training service uses the pre-processed additional historical data during training to generate the trained product match ML model 152.

In an embodiment, the pre-processing and training can be done as batch training. In this embodiment, all data is pre-processed at once (e.g., all historical insurance product data and additional historical data), and provided to the training service at block 608. Alternatively, the pre-processing and training can be done in a streaming manner. In this embodiment, the data is streaming, and is continuously pre-processed and provided to the training service. For example, it can be desirable to take a streaming approach for scalability. The set of training data may be very large, so it may be desirable to pre-process the data, and provide it to the training service, in a streaming manner (e.g., to avoid computation and storage limitations). Further, in an embodiment, a federated learning approach could be used in which multiple entities contribute to training a shared model.

FIG. 7 is a flowchart 700 illustrating inferring a product match using an ML model, according to one embodiment. A processing service 116, as discussed above in relation to FIGS. 1-2, is associated with a product match ML model 152. In an embodiment, product match ML model 152 is trained to predict a product match 730 for a user. For example, the product match ML model 152 can predict a match between a user and a pooled risk product, as discussed above in relation to FIG. 5. This is merely an example, and the product match ML model 152 can be used to predict a match between a user and any suitable product, including a VPL product as discussed below in relation to FIG. 17.

In an embodiment, processing service 116 uses multiple types of data to predict a product match 730, using the product match ML model 152. For example, the processing service 116 can use available pooled products 702 and user risk characteristics 704. The available pooled products 702 can reflect different risk pools available to the user, and the user risk characteristics 704 can reflect the risk characteristics of the user purchasing a product. The processing service 116 can use the product match ML model 152 to infer (e.g., predict) a likely product match 730 between the user risk characteristics 704 and the available pooled products 702.

In an embodiment, the product match 730 reflects a predicted best match for the user among the available pooled products 702, based on the user risk characteristics 704. Alternatively, or in addition, the product match 730 identifies multiple suggested matches. In an embodiment, the user can the select a preferred option among the multiple suggested matches, one or more rules could be used to select among options, or any other suitable technique can be used.

FIG. 8 is a flowchart illustrating matching a user to investment options, according to one embodiment. In an embodiment, FIG. 8 corresponds to block 422 illustrated in FIG. 4. At block 802 a UI service (e.g., the UI service 114 illustrated in FIGS. 1-2) determines whether to recommend an investment composition. In an embodiment, recommending an investment composition is optional. For example, a user can select whether to have a recommended investment composition. Alternatively, or in addition, the UI service can be configured to always, or never, provide a recommended investment composition. If the UI service determines to provide a recommended investment composition, the flow proceeds to block 804. If not, the flow proceeds to block 818 and the UI service presents the user with standard (e.g., default) investment options.

At block 804, the UI service queries the user for basic data to provide the recommended investment options. For example, the UI service can provide a questionnaire to the user regarding various characteristics of the user (e.g., age, income level, dependents, or any other suitable characteristics). This is merely an example, and the UI service can query the user for any suitable data using any suitable technique (e.g., a textual questionnaire, a video questionnaire, an audio questionnaire, or any other suitable technique).

At block 806, the UI service queries the user for risk tolerance using a questionnaire. In an embodiment, the UI service can present a series of questions (e.g., textual questions, audio questions, video questions, or any other suitable format of questions) relating to the user's risk tolerance. For example, if the user is insuring property (e.g., real property or personal property) the UI service could query the user about how long the user intends to own the property. If the user is acquiring health insurance, the service could query the user about any other supplemental insurance purchased (e.g., a high deductible health insurance plan intended to cover only emergencies could be combined with an individual insurance investment product to cover lesser expenses, and this could affect the user's risk tolerance).

As another example, the UI service could query the user about whether a short term decline at a particular threshold (e.g., 5%, 10%, 20%, or any other suitable threshold) would stress the user economically in the event the user makes a claim on the individual insurance investment product. That is, as discussed above, the individual insurance investment product provides funds to satisfy a potential insurance claim by the user. The UI service can query the user to determine whether changes to the available funds to satisfy such a claim would be economically problematic for the user. As discussed below, a customized investment recommendation (e.g., with a customized level of risk) can be provide to the user based on the responses to these questions.

In an embodiment, querying for risk tolerance is particular advantageous for users that are insuring for small claims (e.g., to cover deductibles in traditional insurance policies). For example, a user generating an individual insurance product to cover a $5,000 property or health insurance deductible may be very sensitive to potential loss of funds, in the event of a claim, and thus could be recommended a less risky (but potentially lower rate of return) investment option. By contrast, a user generating an individual insurance product to cover a multi-million dollar property, or a health insurance product supplemented by another emergency health insurance plan, may be less sensitive to potential losses, and thus could be recommended a riskier (but potentially higher rate of return) investment option.

At block 808, a processing service (e.g., the processing service 116 illustrated in FIGS. 1-2) determines whether to perform an ML investment match. In an embodiment, the processing service can use a suitable ML model (e.g., the investment match ML model 154 illustrated in FIGS. 1-2) to infer a match between the user's characteristics (e.g., the basic data gathered at block 804 and the risk tolerance data gathered at block 806, any combination thereof, or any other suitable data) and an investment recommendation. For example, this can be an optional feature, set by the user, by the provider of the individual insurance investment product, or set by any other suitable entity or using any other suitable technique. If the processing service determines to use an ML investment match, the flow proceeds to block 810.

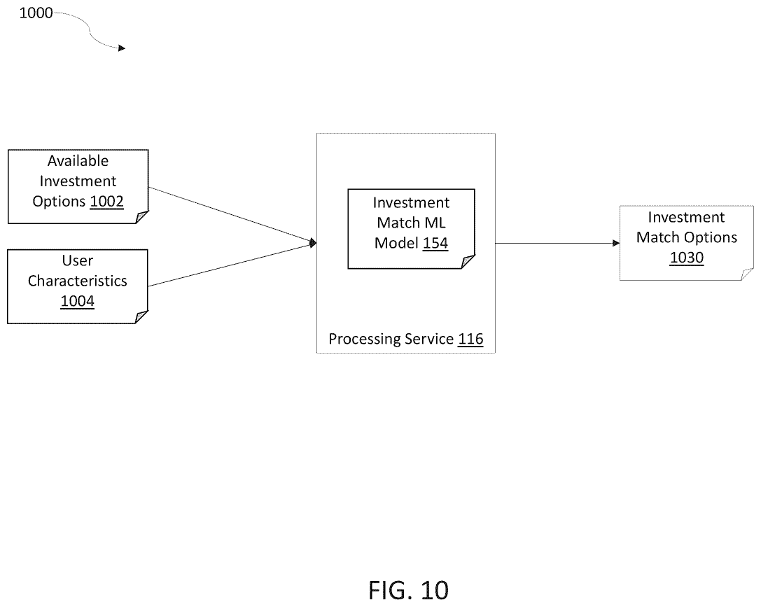

At block 810, the processing service infers investment recommendations using ML. In an embodiment, the processing service uses a suitable ML model (e.g., the investment match ML model 154 illustrated in FIGS. 1-2) to infer predicted matching investment recommendations for the user. This is discussed further, below, with regard to FIG. 10.

Returning to block 808, if the processing service determines not to use an ML investment match, the flow proceeds to block 812. At block 812, the processing service generates rule based investment recommendations (e.g., without using an ML model). In an embodiment, the processing service maintains one or more rules in a suitable electronic repository (e.g., an electronic database) and uses the rules to generate investment recommendations based on the user characteristics (e.g., the basic data gathered at block 804 and the risk tolerance data gathered at block 806, any combination thereof, or any other suitable data).

While FIG. 8 illustrates rules based recommendations and ML based predicted matching as alternatives, this is merely an example. In an embodiment, the processing service uses both rules based recommendations and ML based predicted matching. For example, the processing service can use one more rules to pre-process user data before providing it to the ML model, to narrow the set of available investment recommendations for matching by the ML model, or for any other suitable purpose. As another example, the processing service can select a subset (e.g., one or more) of the predicted investment recommendations from the ML model (e.g., after inference by the ML model).

At block 814, the UI service presents estimated gain and savings. In an embodiment, the UI service provides a product investment tool to inform the user about potential gains, savings, or both, from the recommended investment options. For example, for each style of investment (e.g., S&P large cap, S&P midcap, S&P small cap, NASDAQ technology (QQQQs), bonds, cryptocurrency, or any other suitable investment option), the UI can provide a policy estimator to estimate future benefits available. The UI service can calculate the estimated compound annual growth rate (CAGR), or any other suitable metric, for a recommended investment option over a given time period (e.g., a time period selected by the user, calculated based on the user characteristics, or inferred using an ML model). In an embodiment, the UI service can provide an estimated product value at any desired date.

In an embodiment, the UI service further provides a product savings estimator and excess coverage selector. For example, assume a user is insuring a house with a replacement value of $100,000. The user likely has an existing traditional property insurance policy with a deductible and periodic premium (e.g., monthly or annual fee), or may be in the market to purchase a traditional policy. The UI service can query the user for details of the existing policy, or parameters of a desired policy (e.g., deductible, policy limits, and other suitable data). The processing service can identify and demonstrate potential savings (e.g., monthly or annual savings) to the user by supplementing the traditional policy with an individual insurance investment product. For example, a user may be able to increase the deductible on a traditional policy from $500 to $20,000 at a significant annual savings in traditional insurance premiums. The user could then generate an individual insurance investment product to cover the $20,000 deductible, allowing the user to both save on annual premiums without taking on the additional risk of a $20,000 deductible. In the event of a claim, the self-funded individual insurance investment product would cover the $20,000 deductible, while any additional claim value would be covered by the traditional insurance policy. In an embodiment, the UI service provides estimates of potential savings to the user by using an individual insurance investment product.

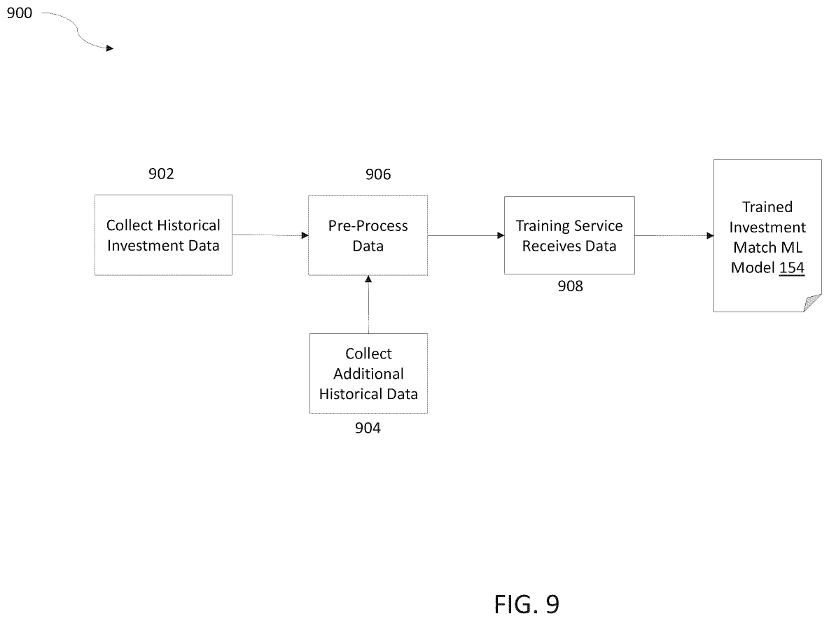

FIG. 9 is a flowchart 900 further illustrating training an investment match ML model, according to one embodiment. This is merely an example, and in an embodiment a suitable unsupervised technique could be used (e.g., without requiring training). At block 902, a training service (e.g., a human administrator or a software or hardware service) collects historical investment data. For example, a processing service (e.g., the processing service 116 illustrated in FIGS. 1-2) can be configured to act as a training service, and can collect historical data reflecting investment characteristics and outcomes for users (e.g., gathered over time).

At block 906, the training service (or other suitable service) pre-processes the collected historical investment data. For example, the training service can create feature vectors reflecting the values of various features, for each collected investment option selected by a prior user. At block 908, the training service receives the feature vectors and uses them to train a trained investment match ML model 154.

In an embodiment, at block 904 the training service also collects additional historical data. For example, the training service can use prior claim data (e.g., data relating to prior claims for individual insurance products made by users), prior regulatory data (e.g., data reflecting prior regulatory success or failure of various individual insurance products), prior user feedback data (e.g., surveys and other suitable reflections of user feedback for prior individual insurance products), and any other suitable data At block 906, the training service can also pre-process this additional historical data. For example, the feature vectors corresponding to the historical insurance product data can be further annotated using the additional historical data. Alternatively, or in addition, additional feature vectors corresponding to the additional historical data can be created. At block 908, the training service uses the pre-processed additional historical data during training to generate the trained investment match ML model 154.

In an embodiment, the pre-processing and training can be done as batch training. In this embodiment, all data is pre-processed at once (e.g., all historical insurance product data and additional historical data), and provided to the training service at block 908. Alternatively, the pre-processing and training can be done in a streaming manner. In this embodiment, the data is streaming, and is continuously pre-processed and provided to the training service. For example, it can be desirable to take a streaming approach for scalability. The set of training data may be very large, so it may be desirable to pre-process the data, and provide it to the training service, in a streaming manner (e.g., to avoid computation and storage limitations). Further, in an embodiment, a federated learning approach could be used in which multiple entities contribute to training a shared model.

FIG. 10 is a flowchart 1000 illustrating inferring an investment match using an ML model, according to one embodiment. A processing service 116, as discussed above in relation to FIGS. 1-2, is associated with an investment match ML model 154. In an embodiment, an investment match ML model 154 is trained to predict investment match options 1030 for a user. For example, the investment match ML model 154 can predict a match between a user and an investment option, as discussed above in relation to FIG. 8. As another example, the investment match ML Model 154 can predict a match between a user and an investment for a back-to-back insurance product, as discussed below in relation to FIGS. 15-16. These are merely examples, and the investment match ML model 154 can be used to predict a match between a user and an investment for any suitable insurance product.

In an embodiment, the processing service 116 uses multiple types of data to predict investment match options 1030, using the investment match ML model 154. For example, the processing service 116 can use available investment options 1002 and user characteristics 1004. The available investment options 1002 can reflect different investment options available to the user, and the user characteristics 1004 can reflect the characteristics of the user purchasing a product (e.g., collected using one or more questionnaires as discussed above in relation to FIG. 8). The processing service 116 can use the investment match ML model 154 to infer (e.g., predict) likely investment match options between the user characteristics 1004 and the available investment options 1002.

In an embodiment, the investment match options 1030 reflects a predicted best match for the user among the available investment options 1002, based on the user characteristics 1004. Alternatively, or in addition, the investment match options 1030 identify multiple suggested matches. In an embodiment, the user can the select a preferred option among the multiple suggested matches, one or more rules could be used to select among options, or any other suitable technique can be used.

FIGS. 11A-B illustrate a user interface for an individual insurance investment product, according to one embodiment. FIG. 11A illustrates a product match user interface, according to one embodiment. In an embodiment, FIG. 11A illustrates an example user interface associated with block 406 illustrated in FIG. 4, as discussed above. This is merely an example, and any suitable user interface can be provided. Further, the user interfaces of FIGS. 11A-B can be adapted for any suitable insurance product, including a back-to-back insurance product as discussed below in relation to FIGS. 15-16 and an insurance savings account as discussed below in relation to FIG. 18.

A user interface 1100 includes user information 1102 and insurance type information 1104. In an embodiment, the user information 1102 presents biographical information for the user (e.g., name, date of birth, or any other suitable biographical information, a user identifier, or any other user information. The insurance type information 1104 presents the type of insurance (e.g., property, health, dental, vehicle, personal injury, or any other suitable insurance).

A menu 1112 (e.g., a drop-down menu) allows the user to select between product types. For example, a user can select between a pooled product and an individual product. For example, as discussed above in relation to block 406 and FIG. 5, a user may be required (or may choose) to purchase a product that is part of a risk pool. The user can select pooled product, if they wish, or individual product if they wish to acquire an individual product.

A user interface element 1114 (e.g., a check-box) allows a user to select whether to match regulations. As discussed above in relation to FIG. 1, in an embodiment a processing layer (e.g., the processing layer 110) interacts with a regulatory layer. Selecting the user interface clement 1114 can instruct a processing service (e.g., the processing service 116 illustrated in FIGS. 1-2) to use the regulatory layer to identify required regulations and match regulations for the product match. In one example, this can include automatically selecting the appropriate option in the menu 1112 (e.g., pooled or individual) based on regulatory requirements. As another example, the processing service can identify any other regulatory requirements (e.g., a required size of pool required, a required quantity of funds for the pool, a required location for the pool, or any other suitable requirements. The processing layer can automatically provide only product matches that meet the regulatory requirements, when the user interface element 1114 is selected.

A user interface element 1116 (e.g., a check-box) allows a user to select whether to use an AI product match (e.g., an ML product match). As discussed above in relation to FIGS. 5-7, in an embodiment a processing service uses a suitable ML model to match products for the user. Selection of the user interface element 1116 can enable, or disable, this feature.

A user interface element 1120 (e.g., a table or list) presents the matched product options. For example, the user interface element 1120 can reflect the output of the ML product match, where the user interface element 1116 is selected. In an embodiment, the user can choose their preferred product by selecting an entry in the matched product options 1120.

FIG. 11B illustrates an investment match user interface, according to one embodiment. In an embodiment, FIG. 11B illustrates an example user interface associated with block 422 illustrated in FIG. 4, as discussed above. This is merely an example, and any suitable user interface can be provided.

A user interface 1150 includes user information 1152 and insurance type information 1154. In an embodiment, the user information 1152 and insurance type information 1154 are the same as the user information 1102 and the insurance type information 1104 presented in FIG. 11A. This is merely an example, and the user information 1152 and insurance type information 1154 can present more, less, or different information from the user information 1102 and insurance type information 1104 illustrated in FIG. 11A.

A menu 1152 (e.g., a drop-down menu) allows the user to select between investment options. For example, a user can select between personalized investment options or default investment options. For example, as discussed above in relation to block 422 and FIG. 8, a user may be provided with personalized recommendations for investment options, or default (e.g., standard) investment options.

A user interface element 1154 (e.g., a check-box) allows a user to select whether to conduct a risk tolerance survey. As discussed above in relation to FIG. 8, a risk tolerance survey can be used to provide personalized investment recommendations.

A user interface element 1156 (e.g., a check-box) allows a user to select whether to use an AI investment match (e.g., an ML investment match). As discussed above in relation to FIGS. 8-10, in an embodiment a processing service uses a suitable ML model to match investments for the user. Selection of the user interface element 1156 can enable, or disable, this feature.

A user interface element 1170 (e.g., a table or list) presents the investment options. For example, the user interface element 1170 can reflect the output of the ML investment match, where the user interface element 1156 is selected. In an embodiment, the user can choose their preferred investment by selecting an entry in the investment options 1170.

FIG. 12 is a flowchart illustrating generating an individual insurance investment product using a blockchain, according to one embodiment. In an embodiment, FIG. 12 corresponds with block 430 illustrated in FIG. 4. At block 1202 a processing service (e.g., the processing service 116 illustrated in FIGS. 1-2) initiates product purchase. For example, the processing service can identify and verify the existence of funds to purchase the product. This is merely one example, and the processing service can undertake any suitable initiation techniques.

At block 1204, the processing service determines whether to perform blockchain verification. In an embodiment, the processing service uses a suitable smart contract on a suitable blockchain to memorialize the product purchase. But this is merely one option. For example, a user, entity providing the product, could select whether to perform blockchain verification. Alternatively, all, or no, verification could be performed using the blockchain. If the processing service determines to perform blockchain verification, the flow proceeds to block 1206.

At block 1206, the processing service selects a blockchain. In an embodiment, the processing service can use any suitable blockchain to verify and record the product purchase. For example, the processing service can use a blockchain interface (e.g., the blockchain interface 134 illustrated in FIG. 1) to access any suitable blockchain (e.g., Ethereum, Polygon, Klatyn, Solana, and any other suitable blockchain).

At block 1208, the processing service identifies a smart contract. In an embodiment, a smart contract is a software program stored on a blockchain that can execute desired functionality. For example, multiple different blockchains could each have a smart contract used to record purchase of an individual insurance investment product. Further, a given blockchain could have multiple different smart contracts designed to record purchase of an individual insurance investment product (e.g., different smart contracts for different types of insurance products, different investments, or any other suitable differences in parameters or functionality). The processing service can identify a smart contract, for the selected blockchain, suitable to record purchase of the individual insurance investment product.

At block 1210, the processing service executes the smart contract to record purchase on the blockchain. In an embodiment, the processing service passes any necessary parameters (e.g., purchaser identification, product identification, investment identification, and any other suitable parameters) to the smart contract. The smart contract executes, on the blockchain, and records the product purchase on the blockchain (e.g., on the distributed ledger of the blockchain). In an embodiment, recording the purchase on the blockchain allows for independent verification of the purchase and protects against fraud, misuse, errors, and other issues.

Further, in an embodiment, the smart contract acts as an atomic operation such that only one user is guaranteed to be able to purchase a given product (e.g., particular shares or portions of the product). Attempts to allow multiple users to purchase the same product (e.g., the same product shares) will fail. This allows for multiple different entities to coordinate purchase of individual insurance investment products, for different users, while guaranteeing a single owner for each individual insurance investment product share.

Returning to block 1204, if the processing service determines not to perform blockchain verification, the flow proceeds to block 1212. At block 1212, the processing service purchases the product without blockchain. In an embodiment, the processing service purchases the desired product and memorializes the purchase in a suitable electronic repository. For example, the processing service could use an investment product interface (e.g., the investment product interface 132) to purchase the desired investment products associated with the individual insurance investment product, and to complete the transfer of funds for the purchase. This is merely an example, and the processing service can instead use an on-site service (e.g., another aspect of the processing layer 110) or any other suitable technique to purchase the individual insurance investment product. While FIG. 12 is discussed in the context of an individual insurance investment product, the discussed techniques can be used for any suitable insurance product (e.g., a back-to-back insurance product, an insurance savings account, or any other suitable insurance product).

FIG. 13 is a flowchart 1300 illustrating fulfilling an individual insurance investment product, according to one embodiment. At block 1302, a UI service (e.g., the UI service 114 illustrated in FIGS. 1-2) receives a claim submission. For example, a user can submit a claim for payout of funds from the user's individual insurance investment product, based on an insured loss suffered by the user. While FIG. 13 is discussed in the context of an individual insurance investment product, the discussed techniques can be used to fulfill a claim relating to any suitable insurance product (e.g., a back-to-back insurance product, an insurance savings account, or any other suitable insurance product).

At block 1304, a processing service (e.g., the processing service 116 illustrated in FIGS. 1-2) verifies the user product. In an embodiment, the processing service verifies that the submitting entity is the owner of the claimed product, or otherwise has permission to claim against the product. For example, the ownership of the product could be recorded in a suitable blockchain, as discussed above in relation to FIG. 12. The processing service can verify on the blockchain that the claimed product exist and that the submitting entity is permitted to claim against the product. This is discussed further, below, with regard to FIG. 14. This is merely an example, and the product can be recorded in any suitable electronic repository and verified using any suitable technique.

At block 1306, the UI service receives claim details. In an embodiment, the claimant is required to verify the claim before funds can be disbursed. The verification requirements may vary across jurisdiction, and the UI service can be customized to request only needed information for a given jurisdiction. For example, a claimant may be required to submit photographs describing the claim, an estimate of damages (e.g., from a certified estimator), and a certification of the loss. These are merely examples, and any suitable information can be required or provided. In an embodiment, the UI service identifies needed information for a given jurisdiction dynamically (e.g., at run-time) using a suitable regulatory interface (e.g., the regulatory interface 142 illustrated in FIG. 1) to identify the requirements. The UI service can then generate a suitable UI to requires the needed information.

At block 1308, the processing service determines whether the claim is valid. In an embodiment, the processing service uses automated techniques to verify the claim. For example, the processing service could use computer vision techniques (e.g., ML based computer vision techniques, including a suitably trained DNN or convolutional neural network (CNN), or any other suitable computer vision technique) to verify photographs associated with the claim. The processing service could verify that any depicted object(s) match insured object(s), verify the extent of damage to the object(s), and verify any other aspects of the claim. Further, a human reviewer could also verify the claim (e.g., in addition to, or instead of, automated techniques).

If the claim is valid, the flow proceeds to block 1310. At block 1310, the processing service sells the investment necessary to pay the claim. For example, the individual insurance investment product could contain more funds than are necessary to pay the claim. The processing service can identify the portion of the product that must be sold (e.g., the number or fraction of shares in an investment fund or any other suitable entity) and can sell the investment.

At block 1312, the processing service disburses funds to pay the claim. In an embodiment, the funds gained from selling the investment at block 1310 are paid to the claimant.

Returning to block 1308, if the claim is not valid the flow proceeds to block 1314. At block 1314, the UI service notifies the claimant. For example, the UI service can provide a suitable textual or audio message to the claimant identifying the claim as invalid, and explaining the problems with the claim submission (e.g., missing or incorrect information). The flow then returns to block 1302, and the claimant can submit another claim (e.g., with corrected or additional information).

FIG. 14 is a flowchart illustrating verifying an individual insurance investment product using a blockchain, according to one embodiment. In an embodiment, FIG. 14 corresponds with block 1304 illustrated in FIG. 13. At block 1402, a processing service (e.g., the processing service 116 illustrated in FIGS. 1-2) identifies claimant information. For example, the processing service can receive identifiers for the claimant and the product. While FIG. 14 is discussed in the context of an individual insurance investment product, the discussed techniques can be used for any suitable insurance product (e.g., a back-to-back insurance product, an insurance savings account, or any other suitable insurance product).

At block 1404, the processing service determines whether to undertake blockchain verification. As discussed above in relation to FIG. 12, in an embodiment purchase of an individual insurance investment product can be recorded in a suitable blockchain. But this is merely one option. If the processing service determines to undertake blockchain verification, the flow proceeds to block 1406.

At block 1406, the processing service uses a smart contract to verify the product on the blockchain. In an embodiment, a smart contract is a software program stored on a blockchain that can execute desired functionality. The processing service can identify a blockchain used to record the product purchase, and can identify a smart contract configured to verify the product purchase on that blockchain. The processing service can execute the identified smart contract to verify the product (e.g., execute the smart contract with parameters identifying the claimant and product, and receive in return a Boolean value identifying whether the blockchain records ownership of the product by the claimant).

Returning to block 1404, if the processing service determines not to perform blockchain verification, the flow proceeds to block 1408. At block 1408, the processing service verifies the product without blockchain. For example, the product information can be recorded in a suitable electronic repository (e.g., an electronic database or any other suitable electronic repository) and the processing service can verify that the claimant owns the product, using the information in the repository (e.g., using a database query).

FIG. 15 is a flowchart 1500 illustrating generating and fulfilling a back-to-back insurance product, according to one embodiment. At block 1502 a user acquires a policy from an insurer (e.g., using the user device 102 illustrated in FIG. 1). For example, a UI service (e.g., the UI service 114 illustrated in FIGS. 1-2) can generate a user interface for acquiring a policy from an insurer. The user interface can allow a user to identify insurance preferences, provide recommended insurance options (e.g., using a suitable ML model or rules-based technique), and allow a user to select an insurance policy. The user can then acquire the policy by, for example, entering into a contract with the insurer for the policy. In an embodiment, the user can acquire a policy relating to any suitable insurance or combinations of insurance (e.g., health insurance, dental insurance, vehicle insurance (e.g., automobile insurance, motorcycle insurance, boat insurance, personal watercraft insurance, aircraft insurance, or any other suitable vehicle insurance), personal injury insurance, or any other suitable insurance). Further, the user can elect to acquire any suitable amount of insurance coverage with a corresponding premium.

In an embodiment, the UI service provides the user interface to a user device (e.g., the user device 102 illustrated in FIGS. 1-2). For example, the UI service can generate a suitable web interface, mobile application interface, desktop application interface, or any other suitable interface, and can provide the interface to the user device. The UI service can transmit the user interface to the user device using a suitable communication network and any suitable communication technique, as discussed above in relation to FIG. 1.

At block 1504, the user selects an investment option. In an embodiment, the user can select a policy at block 1502 (e.g., for any suitable insurance, as discussed above), and then can select an investment option to back the policy at block 1504. For example, the user can identify a preferred investment product or account (e.g., an exchange traded fund (ETF)). As another example, a suitable ML model (e.g., the investment match ML model 154 illustrated in FIGS. 1-2) can be used to match the user with a suitable investment product. This is discussed further, below, with regard to FIG. 16.

At block 1506, the insurer invests the premiums. For example, the user can elect to pay $100,000 in premiums for the insurance policy. The insurer can invest this $100,000 in premiums, using the investment option selected at block 1504. The insurance coverage provided to the user can then correspond to this investment (e.g., the initial premium amount along with any appreciation or depreciation from the investment). In an embodiment, the insurer can use a processing service (e.g., the processing service 116 illustrated in FIGS. 1-2) to invest the premiums. In an embodiment, as discussed above, the processing service can interact with an investment product interface (e.g., the investment product interface 132 illustrated in FIG. 1) to invest the premiums. For example, the processing service can interact with a third party investment entity to invest the premiums, as preferred by the user (e.g., based on selected investment options discussed above in relation to block 1504).

At block 1508, the processing service determines whether a valid claim is submitted. For example, after the insurance policy has been acquired, the UI service (or any other suitable software service) can generate a user interface to allow a user to submit a claim against the product. The processing service can verify whether the claim is valid. This is discussed further, above, with regard to FIGS. 13-14. If the claim is valid, the flow proceeds to block 1510. If not, the flow returns to block 1506 and the premiums continue to be invested.

At block 1510, the processing service fulfills the claim. For example, assuming the claim is valid, the processing service can pay the claim out of the funds invested using the premium. This is discussed further, above, with regard to FIG. 13. In an embodiment, the amount of insurance coverage (e.g., the maximum claim that can be fulfilled) is based on the initial premium paid and the investment performance over time (e.g., appreciation or depreciation).

FIG. 16 is a flowchart illustrating selecting an investment option for a back-to-back insurance product, according to one embodiment. In an embodiment, FIG. 16 relates to block 1504 illustrated in FIG. 15, above. As discussed above, in an embodiment an investment option can be selected directly based on user preferences or using a suitable ML model. At block 1602, use a processing service (e.g., the processing service 116 illustrated in FIGS. 1-2) determines whether to undertake an ML investment match. In an embodiment, a suitable ML model (e.g., the investment match ML model 154 illustrated in FIGS. 1-2) can infer an investment match for the user. This can be an optional feature, such that the processing service can proceed to block 1606 and infer the investment using the ML model, or can proceed to block 1604 and select the investment based on user identification. If ML investment match is used, the flow proceeds to block 1606.

At block 1606, the processing service infers the investment using an ML model. For example, the processing service can use the ML model to infer an investment based on user preferences. This is discussed further, above, with regard to FIGS. 9-10. In an embodiment, a suitable ML model (e.g., the trained investment match ML model 154 illustrated in FIG. 9) is trained to match a user to a suitable investment for the back-to-back insurance product (e.g., as discussed above in relation to FIG. 9). The ML model can then be used to infer the investment match (e.g., as discussed above in relation to FIG. 10).

Returning to block 1604, if there is not an ML investment match, the flow proceeds to block 1604. At block 1604, a user identifies the investment. For example, the user can provide investment preferences, can identify a specific desired investment, or can provide any other suitable information. The insurer can acquire an investment matching the user's identified investment (e.g., an exact match, a similar investment, or any other suitable investment). For example, a user might identify general investment guidelines, and a processing service can acquire an investment meeting the identified guidelines.

FIG. 17 is a flowchart 1700 illustrating variable policy limits (VPL) for an insurance product, according to one embodiment. As discussed above, in an embodiment, a back-to-back insurance product (or any other suitable insurance product, including an individual insurance investment product) can also include VPL for various entities (e.g., various entities in a shared risk pool). At block 1702, a processing service (e.g., the processing service 116 illustrated in FIGS. 1-2) determines whether VPLs are to be used. In an embodiment, this can depend on user preferences, insurer preferences, regulations, or any other suitable criteria. If VPLs are not to be used, the flow proceeds to block 1704 and the processing service applies uniform limits (e.g., the same limit for each entity in a pool).

If VPL are to be used, the flow proceeds to block 1706. At block 1706, the processing service applies a policy cap for claims. For example, one insured entity could have $100,000 in coverage, another entity could have $1,000,000 in coverage, and another could have $10,000,000 in coverage. The processing service can apply these variable caps to determine the maximum claim permitted for each given insured entity.

In an embodiment, the coverage amount is based on the value of a corresponding investment, for the insured entity, based on the premium paid. For example, an insured entity submitting a $100,000 premium with $10,000 of investment appreciation (e.g., gain) could be entitled to $110,000 in coverage, while an insured entity with a $100,000 premium with $10,000 of investment depreciation (e.g., loss) could be entitled to $90,000 in coverage. The respective policy limit for each entity in the risk pool could be tied to the value of the backed investment account.

At block 1708, the processing service determines whether to add a depreciation hedge. In an embodiment, as noted above, the coverage limit for a given insured entity can decrease over time if the corresponding back-to-back investment depreciates. To avoid insufficient coverage in this situation, the insured could maintain a depreciation hedge (e.g., a put option or other hedge on the premium investment). The processing service could permit the insured entity to select whether to add a depreciation hedge (e.g., using a suitable UI). If the insured entity chooses not to add a depreciation hedge, the flow ends. If the insured entity chooses to add a depreciation hedge, the flow proceeds to block 1710. At block 1710, the insured entity can choose a depreciation hedge (e.g., using a suitable UI). For example, the processing service can identify available depreciation hedges (e.g., based on the characteristics of the underlying investment) and can present to the user any, or all, of options for the hedge investment type, recommended hedge amounts, and any other suitable information. The insured entity can then select a desired hedge investment type, amount, or other suitable characteristics, and the processing service can acquire the depreciation hedge on behalf of the insured entity. In one embodiment, the hedge is maintained by the insurer on behalf of the insured entity. Alternatively, the hedge is maintained by the insured entity or a third party entity.

FIG. 18 is a flowchart 1800 illustrating an insurance savings account, according to one embodiment. As discussed above, there are a number of insurance product options potentially suitable for an insured entity, including an individual insurance investment product and a back-to-back insurance product. Alternatively, or in addition, an entity could acquire an insurance savings account (e.g., a self-directed insurance savings account). For example, an entity could invest insurance premium funds in an insurance savings account instead of, or in addition to, acquiring another insurance product.

At block 1802 a processing service (e.g., the processing service 116 illustrated in FIGS. 1-2) generates an insurance savings account. In an embodiment, the insurance savings account could provide similar benefits to a 529 college savings plan, a health savings account (HSA), and other suitable savings account. The processing service can create an insurance investment account for the insured entity.

At block 1804, the user selects investment options. In an embodiment, the insurance savings account is self-directed, and the insured entity selects the desired investments. For example, the user can identify a preferred investment product or account (e.g., an ETF). As another example, a suitable ML model (e.g., the investment match ML model 154 illustrated in FIGS. 1-2) can be used to match the user with a suitable investment product (e.g., as discussed above in relation to FIGS. 9-10). The user can then select the desired investment option.

At block 1806, the processing service funds the account. In an embodiment, the user provides initial funds for the account, and the processing service adds these funds to the account. Further, in an embodiment, the user can add additional funds to the account (over time), and redeem funds from the account (e.g., by submitting a valid claim, as discussed below in relation to block 1808 and 1810).

At block 1808, the processing service determines whether a valid claim is submitted. For example, after the insurance savings account has been funded, a UI service (e.g., the UI service 114 illustrated in FIGS. 1-2) (or any other suitable software service) can generate a user interface to allow a user to submit a claim against the insurance savings account. The processing service can verify whether the claim is valid. This is discussed further, above, with regard to FIGS. 13-14. If the claim is valid, the flow proceeds to block 1810. If not, the flow returns to block 1806 and the insurance savings account continues to hold the funds.

At block 1810, the processing service fulfills the claim. For example, assuming the claim is valid, the processing service can pay the claim out of the funds invested using the insurance savings account. This is discussed further, above, with regard to FIG. 13. In an embodiment, the amount of insurance coverage (e.g., the maximum claim that can be fulfilled) is based on the funds available in the insurance savings account.

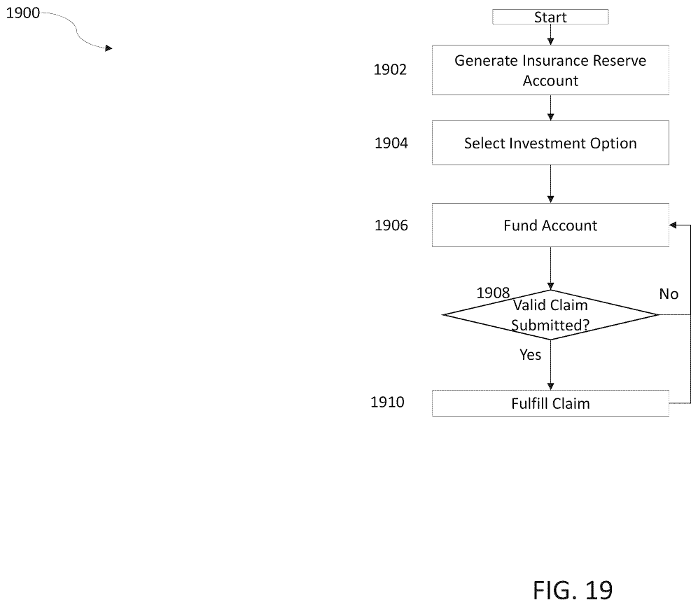

FIG. 19 is a flowchart 1900 illustrating an insurance reserve account, according to one embodiment. A homeowner that purchases a house with a mortgage is typically required by the mortgage lender to maintain insurance on the home (e.g., homeowner's insurance). The insurance is typically associated with a deductible and, in general, the higher the deductible the lower the premium payments for the insurance.

In an embodiment, a homeowner can increase the deductible for insurance (e.g., required homeowner's insurance) using an insurance reserve account. For example, a mortgage lender typically requires that insurance (e.g., homeowner's insurance) is in place at the time of closing on a property purchase. In an embodiment, equity in place at the time of closing (e.g., from a down payment) can be used as collateral for an additional loan (e.g., a home equity line of credit (HELOC)) to fund an insurance reserve account and cover an insurance deductible (e.g., a homeowner's insurance deductible).

As one example, assume a purchaser makes a 20% down payment on a property purchase (e.g., $20,000 for a property purchase of $100,000), and borrows the remaining 80% of the property value (e.g., the remaining $80,000) from a mortgage lender. After closing, the 20% down payment is equity in the property (e.g., $20,000 in equity). This equity can be used as immediate collateral for a HELOC (or any other suitable loan) to fund an insurance reserve account (e.g., a $10,000 insurance investment account to cover a $10,000 homeowner's insurance deductible). For example, after closing on the initial loan (e.g., for the 80% of the property value) the first mortgage is in place with a first lien. A lender (e.g., the same lender as the additional mortgage or a different lender) can then issue another loan, for a fraction of the value of the equity, to fund the insurance reserve account and cover the insurance deductible.

In an embodiment, this is beneficial both to the lender and the purchaser. For example, a lender typically charges a somewhat higher interest rate for a HELOC, as compared to a traditional mortgage. The lender can benefit from this additional interest. And a purchaser can benefit because the higher interest rate for the HELOC is offset by lower insurance premiums (e.g., due to a higher deductible covered by the insurance investment account) and investment benefits from the insurance investment account. Further, the insurance investment account can be initiated and funded long after closing (e.g., using equity as collateral). This allows prior purchasers of a property to fund an insurance investment account, at nearly any time, allowing for increased deductibles (and decreased premiums) along with investment benefits from the insurance investment account.

At block 1902 a processing service (e.g., the processing service 116 illustrated in FIGS. 1-2) generates an insurance reserve account. In an embodiment, the insurance reserve account can be used to fund an insurance deductible (e.g., a homeowner's insurance policy deductible). For example, assume a homeowner purchases a home with a $100,000 mortgage. The homeowner could borrow an additional $10,000 (or any other suitable amount) to fund an escrow account for an insurance deductible for the home. As discussed above, the collateral for this additional $10,000 loan (e.g., a HELOC) could be equity in the home (e.g., from a down payment). Alternatively, or in addition, the homeowner can borrow funds for the insurance reserve account at any time after purchase of the home (e.g., days, weeks, months, or years after purchase), using equity in the home as collateral. For example, a purchaser making a small initial down payment (e.g., a 3.5% down payment or a 0% down payment) could later fund an insurance investment account after sufficient equity has accrued in the property.

In an embodiment, the homeowner can direct the investment of the insurance reserve account, and use the funds to cover an insurance deductible (should the need arise). The homeowner could then withdraw proceeds from the account, should the investment increase. Further, the homeowner can purchase an insurance policy with a lower premium, due to the higher deductible, while the lender is still assured that the homeowner can cover the deductible because of the insurance reserve account.

At block 1904, the user selects investment options. In an embodiment, the insurance reserve account is self-directed, and the insured entity selects the desired investments. For example, the user can identify a preferred investment product or account (e.g., an ETF). As another example, a suitable ML model (e.g., the investment match ML model 154 illustrated in FIGS. 1-2) can be used to match the user with a suitable investment product (e.g., as discussed above in relation to FIGS. 9-10). The user can then select the desired investment option.

For example, a user concerned with meeting payment of the deductible could chose to invest in a less volatile but potentially less profitable investment option (e.g., government treasury bills or any other suitable option), while a user more confident in meeting the deductible could invest in a more volatile but potentially more profitable investment option (e.g., an index fund tied to a suitable stock market, or any other suitable investment option).

At block 1906, the processing service funds the insurance reserve account. In an embodiment, a suitable lender funds the account. For example, as discussed above a lender could provide a HELOC based on equity in the property (e.g., an initial down payment or equity accrued during ownership). This could be the same lender as the initial mortgage lender, or a different lender, and as discussed above the insurance investment account can be funded at closing or at any suitable time. The processing service adds these funds to the account. Further, in an embodiment, the user can add additional funds to the account (over time), and redeem funds from the account (e.g., by submitting a valid claim, as discussed below in relation to block 1908 and 1910). Alternatively, the user (or any other suitable entity) can fund the account initially. In an embodiment, the insurance reserve account is placed in escrow and held to fund the insurance deductible, should it be necessary. This is merely an example, and the insurance reserve account can be held in any suitable manner by any suitable entity.

At block 1908, the processing service determines whether a valid claim is submitted. For example, after the insurance reserve account has been funded, a UI service (e.g., the UI service 114 illustrated in FIGS. 1-2) (or any other suitable software service) can generate a user interface to allow a user to submit a claim against the insurance reserve account. The processing service can verify whether the claim is valid. This is discussed further, above, with regard to FIGS. 13-14. If the claim is valid, the flow proceeds to block 1910. If not, the flow returns to block 1906 and the insurance reserve account continues to hold the funds.

At block 1910, the processing service fulfills the claim. For example, assuming the claim is valid, the processing service can pay the claim out of the funds invested using the insurance reserve account. This is discussed further, above, with regard to FIG. 13. In an embodiment, the amount of coverage (e.g., the maximum deductible that can be fulfilled) is based on the funds available in the insurance reserve account. Further, as noted, in an embodiment the user can redeem excess funds from the account (e.g., based on investment increases over time).

While FIG. 19 is discussed in the context of homeowner's insurance and an escrow account to cover a deductible for the homeowner's insurance, this is merely an example. One or more of these techniques can be applied to any suitable insurance reserve account for any suitable purpose (e.g., health insurance, dental insurance, vehicle insurance (e.g., automobile insurance, motorcycle insurance, boat insurance, personal watercraft insurance, aircraft insurance, or any other suitable vehicle insurance), personal injury insurance, or any other suitable insurance). Further, the insurance reserve account can be used for a deductible, or any other suitable aspect of the insurance account or policy.

### Additional Considerations

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including clement B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a computer, a special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. Any method, apparatus, or system described herein.
